(19) United States
(12) Patent Application Publication
(10) Pub. No.: US 2022/0188885 A1
(43) Pub. Date: Jun. 16, 2022

(54) SYSTEMS AND METHODS FOR CLOUD-BASED DOCUMENT PROCESSING

(71) Applicant: EzCloud123 Inc., Blackwood, NJ (US)

(72) Inventors: Andrew BLACKMAN, Hagerstown, MD (US); Shawn HUMMER, Hagerstown, MD (US); Vikram S, Tamil Nadu (IN); Varun S, Tamil Nadu (IN); Murukesh Kumar S, Tamil Nadu (IN); R. L. SHANMUGAM, Tamil Nadu (IN); Sankaranarayanan MURUGAN, Chennai (IN); Muthu Raman S, Banglore (IN); Gayathri S, Chennai (IN)

(73) Assignee: EzCloud123 Inc., Blackwood, NJ (US)

(21) Appl. No.: 17/546,353

(22) Filed: Dec. 9, 2021

Related U.S. Application Data
(60) Provisional application No. 63/124,166, filed on Dec. 11, 2020.

(51) Int. Cl. G06Q 30/04; G06F 16/182

(52) U.S. Cl. CPC G06Q 30/04; G06F 16/182

(57) ABSTRACT

Systems and methods for extracting parameters from invoice files are provided, including techniques to determine suppliers of invoice files using machine learning models. The system can identify an invoice file in a message, determine an analysis process, such as optical character recognition, for the invoice file based on the invoice file type, and perform an extraction process on the invoice file via a cloud computing system to extract objects from the invoice file. The system can extract invoice parameters from the objects using a first analysis process, and if the first analysis process fails to extract a predetermined set of invoice parameters, perform subsequent analysis processes to extract parameters that the first analysis process failed to extract. The system can then transmit the invoice parameters and the invoice file to a node server.

### CROSS REFERENCE TO RELATED APPLICATION

This application claims the benefit of priority from Provisional Application No. 63/124,166, filed Dec. 11, 2020, the entire contents of which is incorporated herein by reference.

### BACKGROUND

Certain documents, such as invoices, may include common terms in uncommon or unstandardized document formats. For example, invoices are commercial documents that relate to a sale transaction, and can include information about products, quantities, or prices for products and services. However, invoices can be challenging to process because they are not standardized to a common document format or terms, and the items of interest on the invoice may not appear in standard fonts, formats, or positions.

### SUMMARY

It is therefore advantageous for a system to automatically identify and extract relevant portions of invoice documents for later processing. Conventional invoice analysis techniques often require manual intervention to identify, parse, extract, and summarize the contents of an invoice. However, manual techniques are often unreliable and can produce inconsistent or inaccurate results. The systems and methods of this technical solution can process invoice documents by leveraging cloud computing systems. Cloud computing allows for the distributed processing of many invoice documents in parallel, and can provide distributed and efficient backup storage of invoice data. Further, the systems and methods of this technical solution provide a two-step document extraction and analysis process when one extraction method fails, a back-up method is utilized to extract information from the invoice document file. The back-up extraction method can be more thorough, but may incur additional processing delays. By utilizing the back-up extraction and analysis process only when a first, less resource-intensive process fails, the systems and methods of this technical solution can accurately and automatically process invoices in a computationally efficient manner. Therefore, the systems and methods described herein provide a technical improvement to invoice analysis systems.

Additionally, the systems and methods described herein provide techniques for the classification of particular invoices on the supplier level, allowing for supplier-specific invoice processing techniques to be employed. Determining the supplier of an invoice can be challenging because the supplier name or other supplier identifiers may be embedded in a logo or other non-standard graphical representations. In addition, supplier names are challenging to identify because they are not typically associated with a corresponding keyword. For example, a total balance due value may be positioned adjacent to text including some variation of “Total Due,” while supplier names lack such keyword identifiers. These non-standard representations of supplier names present issues for conventional text recognition techniques such as optical character recognition (OCR), because the supplier name may not conform to typical text formatting rules (e.g., font, color, size, shape, etc.). To solve these and other issues, the systems and methods described herein extend the functionality of conventional text processing pipelines by introducing a classification model that can classify invoices by supplier. The classification model can be trained based on a database of templates that are maintained for particular organizations, allowing subscribers of the invoice processing platforms to generate customized classification models for their particular subscribers.

At least one aspect of the present disclosure is directed to a method. The method can be performed, for example, by a data processing system having one or more processors coupled to memory. The method can include identifying an invoice file having a file type that was extracted from a message. The method can include determining an extraction process for the invoice file based on the file type. The method can include transmitting, to a cloud computing system, instructions to process the invoice file using the extraction process. The method can include receiving, from the cloud computing system, a response message including one or more objects extracted from the invoice file. The method can include extracting predetermined invoice parameters from the one or more objects using a first analysis process. The method can include determining that the first analysis process failed to extract at least one invoice parameter of the predetermined invoice parameters. The method can include extracting, from the one or more objects, using a second analysis process, the at least one invoice parameter in response to determining that the first analysis process failed to extract the at least one invoice parameter. The method can include transmitting, to a node server in response to extracting the at least one invoice parameter using the second analysis process, a data structure including the predetermined invoice parameters extracted using the first analysis process and the at least one invoice parameter extracted using the second analysis process.

In some implementations, the method can include receiving the message from a client device. In some implementations, the method can include identifying the invoice file and the file type of the invoice file based on the message. In some implementations, the method can include extracting the invoice file from the message for storage in one or more data structures.

In some implementations, the message is an email message, and the invoice file is an attachment included in the email message. In some implementations, determining the extraction process for the invoice file can include determining that the file type of the invoice file does not match one or more predetermined file types. In some implementations, determining the extraction process for the invoice file can include flagging the invoice file as unrecognized.

In some implementations, receiving the response message from the cloud computing system can include transmitting, to the cloud computing system, a status request message identifying the extraction process for the invoice file. In some implementations, receiving the response message from the cloud computing system can include receiving, from the cloud computing system, a status response message indicating that the extraction process for the invoice file is complete. In some implementations, receiving the response message from the cloud computing system can include transmitting, to the cloud computing system, a results request message identifying the extraction process for the invoice file. In some implementations, receiving the response message from the cloud computing system can include receiving, from the cloud computing system, the response message including the one or more objects in response to the results request message.

In some implementations, the method can include determining that the file type of the invoice file does not match a predetermined file type. In some implementations, the method can include converting the invoice file to the predetermined file type. In some implementations, the first analysis process is a traverse-based rule extraction process. In some implementations, extracting predetermined invoice parameters from the one or more objects can include extracting invoice metadata including at least one of an invoice number, a due date, or an amount due. In some implementations, the second analysis process is a regular-expression extraction process.

In some implementations, determining that the first analysis process failed to extract at least one invoice parameter can include identifying at least one of an invoice number, a due date, or an amount due that was not extracted using the first analysis process. In some implementations, the method can include determining that both the first analysis process and the second analysis process failed to extract the at least one invoice parameter from the one or more objects. In some implementations, the method can include flagging the invoice file as unrecognized responsive to determining that the first analysis process and the second analysis process failed.

In some implementations, extracting the predetermined invoice parameters from the objects is further based on a supplier of the invoice file. In some implementations, the method can include determining the supplier of the invoice file by executing a machine learning classifier using the invoice file as input. In some implementations, the method can include training the machine learning classifier using a set of training data comprising one or more templates and respective ground-truth data.

At least one other aspect of the present disclosure is directed to a system. The system can include a data processing system comprising one or more processors coupled to memory. The system can identify an invoice file having a file type that was extracted from a message. The system can determine an extraction process for the invoice file based on the file type. The system can transmit, to a cloud computing system, instructions to process the invoice file using the extraction process. The system can receive, from the cloud computing system, a response message including one or more objects extracted from the invoice file. The system can extract predetermined invoice parameters from the one or more objects using a first analysis process. The system can determine that the first analysis process failed to extract at least one invoice parameter of the predetermined invoice parameters. The system can extract, from the one or more objects, using a second analysis process, the at least one invoice parameter responsive to determining that the first analysis process failed to extract the at least one invoice parameter. The system can transmit, to a node server, responsive to extracting the at least one invoice parameter using the second analysis process, a data structure including the predetermined invoice parameters extracted using the first analysis process and the at least one invoice parameter extracted using the second analysis process.

In some implementations, the system can receive the message from a client device. In some implementations, the system can identify the invoice file and the file type of the invoice file based on the message. In some implementations, the system can extract the invoice file from the message for storage in one or more data structures. In some implementations, the system can determine that the file type of the invoice file does not match a predetermined file type. In some implementations, the system can convert the invoice file to the predetermined file type.

In some implementations, the first analysis process is a traverse-based rule extraction process. In some implementations, to extract predetermined invoice parameters from the one or more objects, the system can extract invoice metadata including at least one of an invoice number, a due date, or an amount due. In some implementations, the system can extract the predetermined invoice parameters from the objects further based on a supplier of the invoice file. In some implementations, the system can determine the supplier of the invoice file by executing a machine learning classifier using the invoice file as input. In some implementations, the system can train the machine learning classifier using a set of training data comprising one or more templates and respective ground-truth data.

At least one other aspect of the present disclosure is directed to another method. The method may be performed, for example, by a data processing system that includes one or more processors and a memory. The method can include determining an extraction process for a document based on a file type of the document. The method can include transmitting, to a cloud computing system, instructions to process the document using the extraction process. The method can include receiving, from the cloud computing system, a response message including one or more objects extracted from the invoice file. The method can include extracting predetermined parameters from the one or more objects using a first analysis process. The method can include determining that the first analysis process failed to extract at least one parameter. The method can include, extracting, from the one or more objects, using a second analysis process, the at least one parameter responsive to determining that the first analysis process failed to extract the at least one parameter. The method can include transmitting, to a node server, responsive to extracting the at least one parameter using the second analysis process, a data structure including the predetermined parameters extracted using the first analysis process and the at least one parameter extracted using the second analysis process.

At least one other aspect of the present disclosure is directed to another method. The method may be performed, for example, by a data processing system that includes one or more processors and a memory. The method can include identifying an invoice file having a file type, the invoice file associated with a supplier identifier. The method can include transmitting, to a cloud computing system, instructions to process the invoice file using an extraction process. The method can include receiving, from the cloud computing system, a response message including one or more objects extracted from the invoice file. The method can include extracting predetermined invoice parameters from the one or more objects based on one or more predetermined keywords associated with the supplier identifier and one or more coordinates identified for the one or more objects.

In some implementations, the method can include determining, using an invoice supplier identifier model, the supplier identifier associated with the invoice file.

These and other aspects and implementations are discussed in detail below. The foregoing information and the following detailed description include illustrative examples of various aspects and implementations, and provide an overview or framework for understanding the nature and character of the claimed aspects and implementations. The drawings provide illustration and a further understanding of the various aspects and implementations, and are incorporated in and constitute a part of this specification. Aspects can be combined and it will be readily appreciated that features described in the context of one aspect of the invention can be combined with other aspects. Aspects can be implemented in any convenient form. For example, by appropriate computer programs, which may be carried on appropriate carrier media (computer readable media), which may be tangible carrier media (e.g. disks or other non-transitory media) or intangible carrier media (e.g. communications signals). Aspects may also be implemented using suitable apparatus, which may take the form of programmable computers running computer programs arranged to implement the aspect. As used in the specification and in the claims, the singular form of ‘a’, ‘an’, and ‘the’ include plural referents unless the context clearly dictates otherwise.

### BRIEF DESCRIPTION OF THE DRAWINGS

The accompanying drawings are not intended to be drawn to scale. Like reference numbers and designations in the various drawings indicate like elements. For purposes of clarity, not every component may be labeled in every drawing. In the drawings:

FIG. 1A is a block diagram depicting an embodiment of a network environment comprising a client device in communication with a server device, in accordance with one or more implementations;

FIG. 1B is a block diagram depicting a cloud computing environment comprising a client device in communication with cloud service providers, in accordance with one or more implementations;

FIGS. 1C and 1D are block diagrams depicting embodiments of computing devices useful in connection with the methods and systems described herein, in accordance with one or more implementations;

FIG. 2 is a block diagram of an example system for extracting parameters from invoices using a cloud computing system, in accordance with one or more implementations;

FIG. 3 illustrates an example flow diagram of a method for extracting parameters from invoices using a cloud computing system, in accordance with one or more implementations;

FIGS. 4A, 4B, 4C, 4D, 4E, 4F, 4G, 4H, 4I, 4J, 4K, and 4L each depict different views of an example user interface that communicates with the systems described herein, in accordance with one or more implementations; and

FIG. 5A depicts a high-level block diagram of the invoice extraction process in an example cloud computing environment, in accordance with one or more implementations;

FIG. 5B depicts a high-level block diagram of a user application accessing data produced and maintained by the example cloud computing environment in FIG. 5A, in accordance with one or more implementations;

FIGS. 6A, 6B, 6C, 6D, and 6E depict various example invoice portions that can be analyzed using the techniques described herein, in accordance with one or more implementations;

FIG. 7 depicts a process flow diagram for generating a machine learning model that classifies documents by supplier, in accordance with one or more implementations;

FIG. 8 depicts a process flow diagram for classifying and extracting information from documents using machine learning models, in accordance with one or more implementations; and

FIG. 9 depicts an example user interface showing an example document and extracted key-pair values, in accordance with one or more implementations.

### DETAILED DESCRIPTION

Below are detailed descriptions of various concepts related to, and implementations of, techniques, approaches, methods, apparatuses, and systems for extracting parameters from invoices using a cloud computing system. The various concepts introduced above and discussed in greater detail below may be implemented in any of numerous ways, as the described concepts are not limited to any particular manner of implementation. Examples of specific implementations and applications are provided primarily for illustrative purposes.

For purposes of reading the description of the various implementations below, the following descriptions of the sections of the Specification and their respective contents may be helpful:

Section A describes a network environment and computing environment which may be useful for practicing embodiments described herein; and

Section B describes systems and methods for cloud-based invoice analysis.

### A. Computing and Network Environment

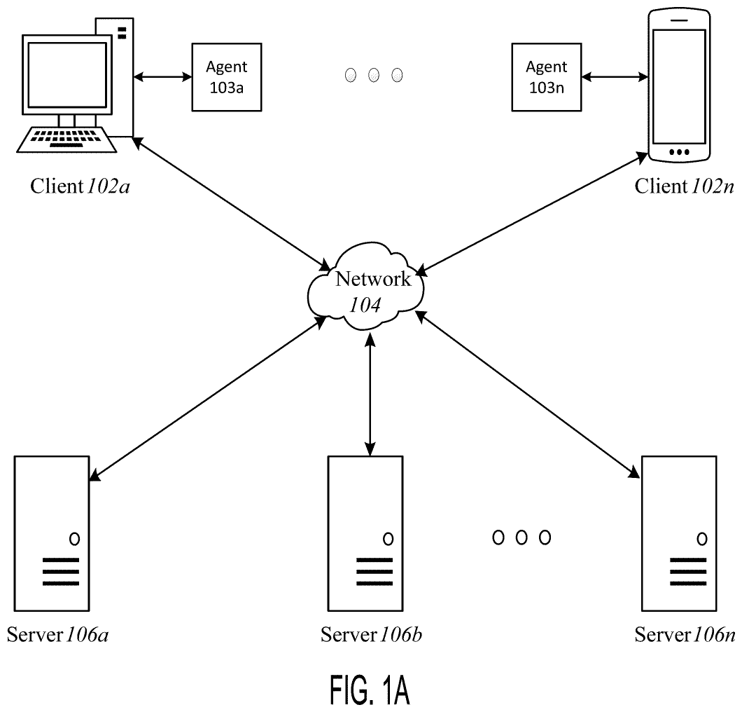

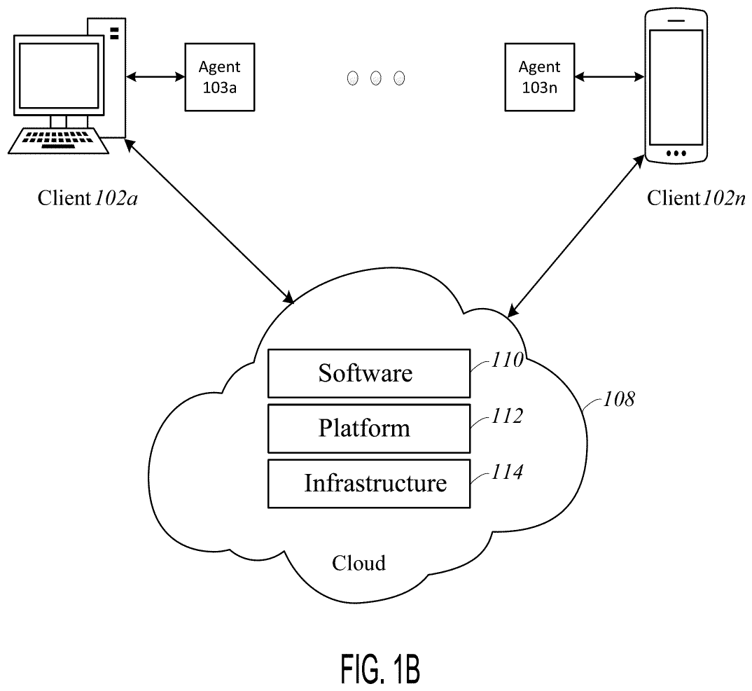

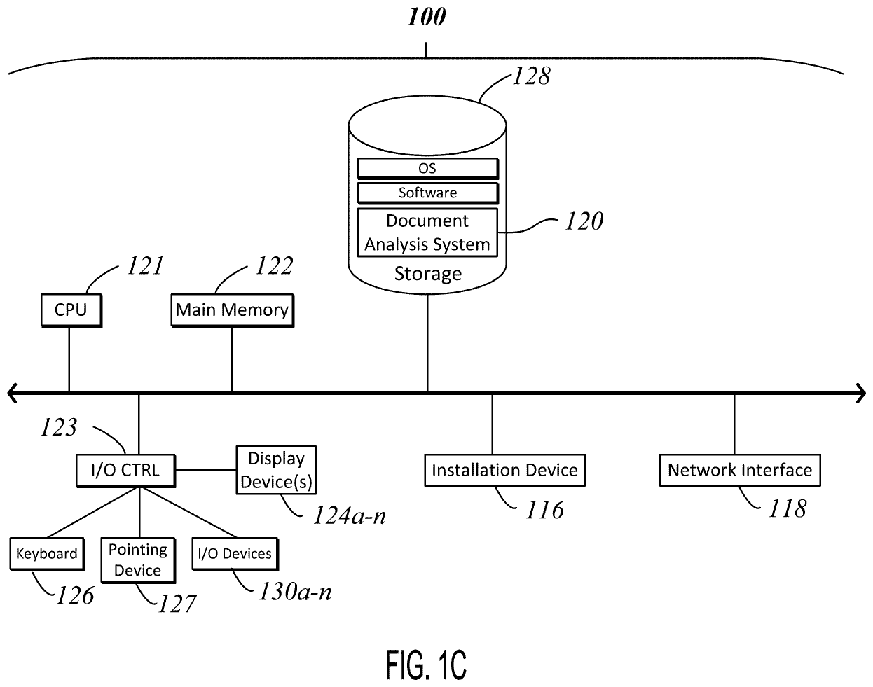

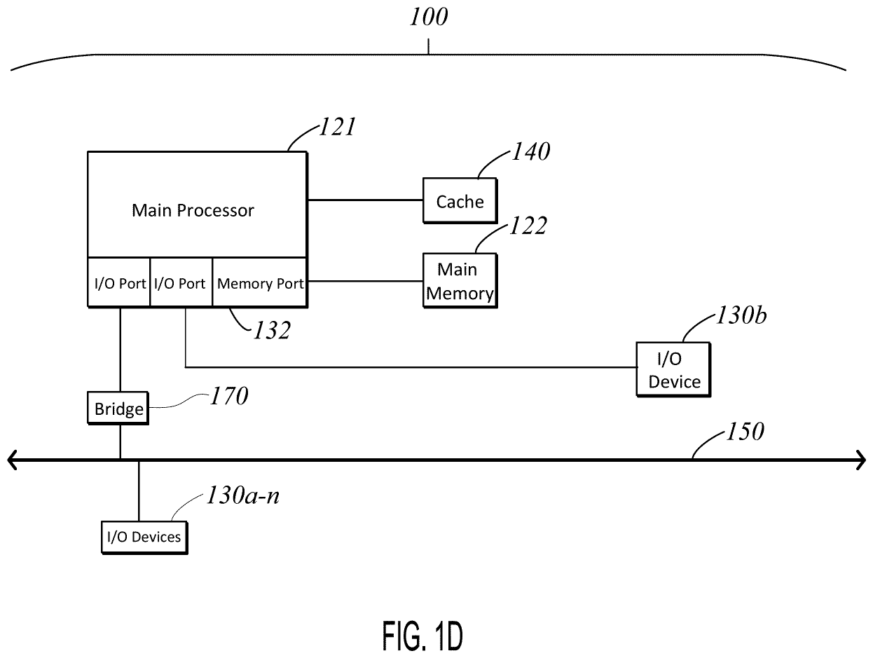

Prior to discussing specific implementations of the various aspects of this technical solution, it may be helpful to describe aspects of the operating environment as well as associated system components (e.g., hardware elements) in connection with the methods and systems described herein. Referring to FIG. 1A, an embodiment of a network environment is depicted. In brief overview, the network environment includes one or more clients 102a-102n (also generally referred to as local machine(s) 102, client(s) 102, client node(s) 102, client machine(s) 102, client computer(s) 102, client device(s) 102, endpoint(s) 102, or endpoint node(s) 102) in communication with one or more agents 103a-103n and one or more servers 106a-106n (also generally referred to as server(s) 106, node 106, or remote machine(s) 106) via one or more networks 104. In some embodiments, a client 102 has the capacity to function as both a client node seeking access to resources provided by a server and as a server providing access to hosted resources for other clients 102a-102n.

Although FIG. 1A shows a network 104 between the clients 102 and the servers 106, the clients 102 and the servers 106 may be on the same network 104. In some embodiments, there are multiple networks 104 between the clients 102 and the servers 106. In one of these embodiments, a network 104′ (not shown) may be a private network and a network 104 may be a public network. In another of these embodiments, a network 104 may be a private network and a network 104′ a public network. In still another of these embodiments, networks 104 and 104′ may both be private networks.

The network 104 may be connected via wired or wireless links. Wired links may include Digital Subscriber Line (DSL), coaxial cable lines, or optical fiber lines. The wireless links may include BLUETOOTH, Wi-Fi, Worldwide Interoperability for Microwave Access (WiMAX), an infrared channel or satellite band. The wireless links may also include any cellular network standards used to communicate among mobile devices, including standards that qualify as 1G, 2G, 3G, or 4G. The network standards may qualify as one or more generation of mobile telecommunication standards by fulfilling a specification or standards such as the specifications maintained by International Telecommunication Union. The 3G standards, for example, may correspond to the International Mobile Telecommunications-2000 (IMT-2000) specification, and the 4G standards may correspond to the International Mobile Telecommunications Advanced (IMT-Advanced) specification. Examples of cellular network standards include AMPS, GSM, GPRS, UMTS, LTE, LTE Advanced, Mobile WiMAX, and WiMAX-Advanced. Cellular network standards may use various channel access methods e.g. FDMA, TDMA, CDMA, or SDMA. In some embodiments, different types of data may be transmitted via different links and standards. In other embodiments, the same types of data may be transmitted via different links and standards.

The network 104 may be any type and/or form of network. The geographical scope of the network 104 may vary widely and the network 104 can be a body area network (BAN), a personal area network (PAN), a local-area network (LAN), e.g. Intranet, a metropolitan area network (MAN), a wide area network (WAN), or the Internet. The topology of the network 104 may be of any form and may include, e.g., any of the following: point-to-point, bus, star, ring, mesh, or tree. The network 104 may be an overlay network which is virtual and sits on top of one or more layers of other networks 104′. The network 104 may be of any such network topology as known to those ordinarily skilled in the art capable of supporting the operations described herein. The network 104 may utilize different techniques and layers or stacks of protocols, including, e.g., the Ethernet protocol, the internet protocol suite (TCP/IP), the ATM (Asynchronous Transfer Mode) technique, the SONET (Synchronous Optical Networking) protocol, or the SDH (Synchronous Digital Hierarchy) protocol. The TCP/IP internet protocol suite may include application layer, transport layer, internet layer (including, e.g., IPv6), or the link layer. The network 104 may be a type of a broadcast network, a telecommunications network, a data communication network, or a computer network.

In some embodiments, the system may include multiple, logically-grouped servers 106. In one of these embodiments, the logical group of servers may be referred to as a server farm 38 (not shown) or a machine farm 38. In another of these embodiments, the servers 106 may be geographically dispersed. In other embodiments, a machine farm 38 may be administered as a single entity. In still other embodiments, the machine farm 38 includes a plurality of machine farms 38. The servers 106 within each machine farm 38 can be heterogeneous—one or more of the servers 106 or machines 106 can operate according to one type of operating system platform (e.g., WINDOWS NT, manufactured by Microsoft Corp. of Redmond, Wash.), while one or more of the other servers 106 can operate according to another type of operating system platform (e.g., Unix, Linux, or Mac OS X).

In one embodiment, servers 106 in the machine farm 38 may be stored in high-density rack systems, along with associated storage systems, and located in an enterprise data center. In this embodiment, consolidating the servers 106 in this way may improve system manageability, data security, the physical security of the system, and system performance by locating servers 106 and high performance storage systems on localized high performance networks. Centralizing the servers 106 and storage systems and coupling them with advanced system management tools allows more efficient use of server resources.

The servers 106 of each machine farm 38 do not need to be physically proximate to another server 106 in the same machine farm 38. Thus, the group of servers 106 logically grouped as a machine farm 38 may be interconnected using a wide-area network (WAN) connection or a metropolitan-area network (MAN) connection. For example, a machine farm 38 may include servers 106 physically located in different continents or different regions of a continent, country, state, city, campus, or room. Data transmission speeds between servers 106 in the machine farm 38 can be increased if the servers 106 are connected using a local-area network (LAN) connection or some form of direct connection. Additionally, a heterogeneous machine farm 38 may include one or more servers 106 operating according to a type of operating system, while one or more other servers 106 execute one or more types of hypervisors rather than operating systems. In these embodiments, hypervisors may be used to emulate virtual hardware, partition physical hardware, virtualize physical hardware, and execute virtual machines that provide access to computing environments, allowing multiple operating systems to run concurrently on a host computer. Native hypervisors may run directly on the host computer. Hypervisors may include VMware ESX/ESXi, manufactured by VMWare, Inc., of Palo Alto, Calif.; the Xen hypervisor, an open source product whose development is overseen by Citrix Systems, Inc.; the HYPER-V hypervisors provided by Microsoft or others. Hosted hypervisors may run within an operating system on a second software level. Examples of hosted hypervisors may include VMware Workstation and VIRTUALBOX.

Management of the machine farm 38 may be de-centralized. For example, one or more servers 106 may comprise components, subsystems and modules to support one or more management services for the machine farm 38. In one of these embodiments, one or more servers 106 provide functionality for management of dynamic data, including techniques for handling failover, data replication, and increasing the robustness of the machine farm 38. Each server 106 may communicate with a persistent store and, in some embodiments, with a dynamic store.

Server 106 may be a file server, application server, web server, proxy server, appliance, network appliance, gateway, gateway server, virtualization server, deployment server, SSL VPN server, or firewall. In one embodiment, the server 106 may be referred to as a remote machine or a node.

Referring to FIG. 1B, a cloud computing environment is depicted. A cloud computing environment may provide client 102 with one or more resources provided by a network environment. The cloud computing environment may include one or more clients 102a-102n, in communication with respective agents 103a-103n and with the cloud 108 over one or more networks 104. Clients 102 may include, e.g., thick clients, thin clients, and zero clients. A thick client may provide at least some functionality even when disconnected from the cloud 108 or servers 106. A thin client or a zero client may depend on the connection to the cloud 108 or server 106 to provide functionality. A zero client may depend on the cloud 108 or other networks 104 or servers 106 to retrieve operating system data for the client device. The cloud 108 may include back end platforms, e.g., servers 106, storage, server farms or data centers.

The cloud 108 may be public, private, or hybrid. Public clouds may include public servers 106 that are maintained by third parties to the clients 102 or the owners of the clients. The servers 106 may be located off-site in remote geographical locations as disclosed above or otherwise. Public clouds may be connected to the servers 106 over a public network. Private clouds may include private servers 106 that are physically maintained by clients 102 or owners of clients. Private clouds may be connected to the servers 106 over a private network 104. Hybrid clouds 108 may include both the private and public networks 104 and servers 106.

The cloud 108 may also include a cloud based delivery, e.g. Software as a Service (SaaS) 110, Platform as a Service (PaaS) 112, and Infrastructure as a Service (IaaS) 114. IaaS may refer to a user renting the use of infrastructure resources that are needed during a specified time period. IaaS providers may offer storage, networking, servers or virtualization resources from large pools, allowing the users to quickly scale up by accessing more resources as needed. Examples of IaaS include AMAZON WEB SERVICES provided by Amazon.com, Inc., of Seattle, Wash., RACKSPACE CLOUD provided by Rackspace US, Inc., of San Antonio, Tex., Google Compute Engine provided by Google Inc. of Mountain View, Calif., or RIGHTSCALE provided by RightScale, Inc., of Santa Barbara, Calif. PaaS providers may offer functionality provided by IaaS, including, e.g., storage, networking, servers or virtualization, as well as additional resources such as, e.g., the operating system, middleware, or runtime resources. Examples of PaaS include WINDOWS AZURE provided by Microsoft Corporation of Redmond, Wash., Google App Engine provided by Google Inc., and HEROKU provided by Heroku, Inc. of San Francisco, Calif. SaaS providers may offer the resources that PaaS provides, including storage, networking, servers, virtualization, operating system, middleware, or runtime resources. In some embodiments, SaaS providers may offer additional resources including, e.g., data and application resources. Examples of SaaS include GOOGLE APPS provided by Google Inc., SALESFORCE provided by Salesforce.com Inc. of San Francisco, Calif., or OFFICE 365 provided by Microsoft Corporation. Examples of SaaS may also include data storage providers, e.g. DROPBOX provided by Dropbox, Inc. of San Francisco, Calif., Microsoft SKYDRIVE provided by Microsoft Corporation, Google Drive provided by Google Inc., or Apple ICLOUD provided by Apple Inc. of Cupertino, Calif.

Clients 102 may access IaaS resources with one or more IaaS standards, including, e.g., Amazon Elastic Compute Cloud (EC2), Open Cloud Computing Interface (OCCI), Cloud Infrastructure Management Interface (CIMI), or OpenStack standards. Some IaaS standards may allow clients access to resources over HTTP, and may use Representational State Transfer (REST) protocol or Simple Object Access Protocol (SOAP). Clients 102 may access PaaS resources with different PaaS interfaces. Some PaaS interfaces use HTTP packages, standard Java APIs, JavaMail API, Java Data Objects (JDO), Java Persistence API (JPA), Python APIs, web integration APIs for different programming languages including, e.g., Rack for Ruby, WSGI for Python, or PSGI for Perl, or other APIs that may be built on REST, HTTP, XML, or other protocols. Clients 102 may access SaaS resources through the use of web-based user interfaces, provided by a web browser (e.g. GOOGLE CHROME, Microsoft INTERNET EXPLORER, or Mozilla Firefox provided by Mozilla Foundation of Mountain View, Calif.). Clients 102 may also access SaaS resources through smartphone or tablet applications, including, e.g., Salesforce Sales Cloud, or Google Drive app. Clients 102 may also access SaaS resources through the client operating system, including, e.g., Windows file system for DROPBOX.

In some embodiments, access to IaaS, PaaS, or SaaS resources may be authenticated. For example, a server or authentication server may authenticate a user via security certificates, HTTPS, or API keys. API keys may include various encryption standards such as, e.g., Advanced Encryption Standard (AES). Data resources may be sent over Transport Layer Security (TLS) or Secure Sockets Layer (SSL).

The client 102 and server 106 may be deployed as and/or executed on any type and form of computing device, e.g. a computer, network device or appliance capable of communicating on any type and form of network and performing the operations described herein. FIGS. 1C and 1D depict block diagrams of a computing device 100 useful for practicing an embodiment of the client 102 or a server 106. As shown in FIGS. 1C and 1D, each computing device 100 includes a central processing unit 121, and a main memory unit 122. As shown in FIG. 1C, a computing device 100 may include a storage device 128, an installation device 116, a network interface 118, an I/O controller 123, display devices 124a-124n, a keyboard 126 and a pointing device 127, e.g. a mouse. The storage device 128 may include, without limitation, an operating system, software, and a document analysis system 120. As shown in FIG. 1D, each computing device 100 may also include additional optional elements, e.g. a memory port 132, a bridge 170, one or more input/output devices 130a-130n (generally referred to using reference numeral 130), and a cache memory 140 in communication with the central processing unit 121.

The central processing unit 121 is any logic circuitry that responds to and processes instructions fetched from the main memory unit 122. In many embodiments, the central processing unit 121 is provided by a microprocessor unit, e.g.: those manufactured by Intel Corporation of Mountain View, Calif.; those manufactured by Motorola Corporation of Schaumburg, Ill.; the ARM processor and TEGRA system on a chip (SoC) manufactured by Nvidia of Santa Clara, Calif.; the POWER7 processor, those manufactured by International Business Machines of White Plains, N.Y.; or those manufactured by Advanced Micro Devices of Sunnyvale, Calif. The computing device 100 may be based on any of these processors, or any other processor capable of operating as described herein. The central processing unit 121 may utilize instruction level parallelism, thread level parallelism, different levels of cache, and multi-core processors. A multi-core processor may include two or more processing units on a single computing component. Examples of a multi-core processors include the AMD PHENOM IIX2, INTEL CORE i5, INTEL CORE i7, and INTEL CORE i9.

Main memory unit 122 may include one or more memory chips capable of storing data and allowing any storage location to be directly accessed by the microprocessor 121. Main memory unit 122 may be volatile and faster than storage 128 memory. Main memory units 122 may be Dynamic random access memory (DRAM) or any variants, including static random access memory (SRAM), Burst SRAM or SynchBurst SRAM (BSRAM), Fast Page Mode DRAM (FPM DRAM), Enhanced DRAM (EDRAM), Extended Data Output RAM (EDO RAM), Extended Data Output DRAM (EDO DRAM), Burst Extended Data Output DRAM (BEDO DRAM), Single Data Rate Synchronous DRAM (SDR SDRAM), Double Data Rate SDRAM (DDR SDRAM), Direct Rambus DRAM (DRDRAM), or Extreme Data Rate DRAM (XDR DRAM). In some embodiments, the main memory 122 or the storage 128 may be non-volatile; e.g., non-volatile read access memory (NVRAM), flash memory non-volatile static RAM (nvSRAM), Ferroelectric RAM (FeRAM), Magnetoresistive RAM (MRAM), Phase-change memory (PRAM), conductive-bridging RAM (CBRAM), Silicon-Oxide-Nitride-Oxide-Silicon (SONOS), Resistive RAM (RRAM), Racetrack, Nano-RAM (NRAM), or Millipede memory. The main memory 122 may be based on any of the above described memory chips, or any other available memory chips capable of operating as described herein. In the embodiment shown in FIG. 1C, the processor 121 communicates with main memory 122 via a system bus 150 (described in more detail below). FIG. 1D depicts an embodiment of a computing device 100 in which the processor communicates directly with main memory 122 via a memory port 132. For example, in FIG. 1D the main memory 122 may be DRDRAM.

FIG. 1D depicts an embodiment in which the main processor 121 communicates directly with cache memory 140 via a secondary bus, sometimes referred to as a backside bus. In other embodiments, the main processor 121 communicates with cache memory 140 using the system bus 150. Cache memory 140 typically has a faster response time than main memory 122 and is typically provided by SRAM, BSRAM, or EDRAM. In the embodiment shown in FIG. 1D, the processor 121 communicates with various I/O devices 130 via a local system bus 150. Various buses may be used to connect the central processing unit 121 to any of the I/O devices 130, including a PCI bus, a PCI-X bus, or a PCI-Express bus, or a NuBus. For embodiments in which the I/O device is a video display 124, the processor 121 may use an Advanced Graphics Port (AGP) to communicate with the display 124 or the I/O controller 123 for the display 124. FIG. 1D depicts an embodiment of a computer 100 in which the main processor 121 communicates directly with I/O device 130b or other processors 121′ via HYPERTRANSPORT, RAPIDIO, or INFINIBAND communications technology. FIG. 1D also depicts an embodiment in which local busses and direct communication are mixed: the processor 121 communicates with I/O device 130a using a local interconnect bus while communicating with I/O device 130b directly.

A wide variety of I/O devices 130a-130n may be present in the computing device 100. Input devices may include keyboards, mice, trackpads, trackballs, touchpads, touch mice, multi-touch touchpads and touch mice, microphones, multi-array microphones, drawing tablets, cameras, single-lens reflex camera (SLR), digital SLR (DSLR), CMOS sensors, accelerometers, infrared optical sensors, pressure sensors, magnetometer sensors, angular rate sensors, depth sensors, proximity sensors, ambient light sensors, gyroscopic sensors, or other sensors. Output devices may include video displays, graphical displays, speakers, headphones, inkjet printers, laser printers, and 3D printers.

Devices 130a-130n may include a combination of multiple input or output devices, including, e.g., Microsoft KINECT, Nintendo Wiimote for the WII, Nintendo WII U GAMEPAD, or Apple IPHONE. Some devices 130a-130n allow gesture recognition inputs through combining some of the inputs and outputs. Some devices 130a-130n provides for facial recognition which may be utilized as an input for different purposes including authentication and other commands. Some devices 130a-130n provides for voice recognition and inputs, including, e.g., Microsoft KINECT, SIRI for IPHONE by Apple, Google Now or Google Voice Search.

Additional devices 130a-130n have both input and output capabilities, including, e.g., haptic feedback devices, touchscreen displays, or multi-touch displays. Touchscreen, multi-touch displays, touchpads, touch mice, or other touch sensing devices may use different technologies to sense touch, including, e.g., capacitive, surface capacitive, projected capacitive touch (PCT), in-cell capacitive, resistive, infrared, waveguide, dispersive signal touch (DST), in-cell optical, surface acoustic wave (SAW), bending wave touch (BWT), or force-based sensing technologies. Some multi-touch devices may allow two or more contact points with the surface, allowing advanced functionality including, e.g., pinch, spread, rotate, scroll, or other gestures. Some touchscreen devices, including, e.g., Microsoft PIXELSENSE or Multi-Touch Collaboration Wall, may have larger surfaces, such as on a table-top or on a wall, and may also interact with other electronic devices. Some I/O devices 130a-130n, display devices 124a-124n or group of devices may be augment reality devices. The I/O devices may be controlled by an I/O controller 123 as shown in FIG. 1C. The I/O controller may control one or more I/O devices, such as, e.g., a keyboard 126 and a pointing device 127, e.g., a mouse or optical pen. Furthermore, an I/O device may also provide storage and/or an installation medium 116 for the computing device 100. In still other embodiments, the computing device 100 may provide USB connections (not shown) to receive handheld USB storage devices. In further embodiments, an I/O device 130 may be a bridge between the system bus 150 and an external communication bus, e.g. a USB bus, a SCSI bus, a FireWire bus, an Ethernet bus, a Gigabit Ethernet bus, a Fibre Channel bus, or a Thunderbolt bus.

In some embodiments, display devices 124a-124n may be connected to I/O controller 123. Display devices may include, e.g., liquid crystal displays (LCD), thin film transistor LCD (TFT-LCD), blue phase LCD, electronic papers (e-ink) displays, flexile displays, light emitting diode displays (LED), digital light processing (DLP) displays, liquid crystal on silicon (LCOS) displays, organic light-emitting diode (OLED) displays, active-matrix organic light-emitting diode (AMOLED) displays, liquid crystal laser displays, time-multiplexed optical shutter (TMOS) displays, or 3D displays. Examples of 3D displays may use, e.g. stereoscopy, polarization filters, active shutters, or autostereoscopic. Display devices 124a-124n may also be a head-mounted display (HMD). In some embodiments, display devices 124a-124n or the corresponding I/O controllers 123 may be controlled through or have hardware support for OPENGL or DIRECTX API or other graphics libraries.

In some embodiments, the computing device 100 may include or connect to multiple display devices 124a-124n, which each may be of the same or different type and/or form. As such, any of the I/O devices 130a-130n and/or the I/O controller 123 may include any type and/or form of suitable hardware, software, or combination of hardware and software to support, enable or provide for the connection and use of multiple display devices 124a-124n by the computing device 100. For example, the computing device 100 may include any type and/or form of video adapter, video card, driver, and/or library to interface, communicate, connect or otherwise use the display devices 124a-124n. In one embodiment, a video adapter may include multiple connectors to interface to multiple display devices 124a-124n. In other embodiments, the computing device 100 may include multiple video adapters, with each video adapter connected to one or more of the display devices 124a-124n. In some embodiments, any portion of the operating system of the computing device 100 may be configured for using multiple displays 124a-124n. In other embodiments, one or more of the display devices 124a-124n may be provided by one or more other computing devices 100a or 100b connected to the computing device 100, via the network 104. In some embodiments software may be designed and constructed to use another computer's display device as a second display device 124a for the computing device 100. For example, in one embodiment, an Apple iPad may connect to a computing device 100 and use the display of the device 100 as an additional display screen that may be used as an extended desktop. One ordinarily skilled in the art will recognize and appreciate the various ways and embodiments that a computing device 100 may be configured to have multiple display devices 124a-124n.

Referring again to FIG. 1C, the computing device 100 may comprise a storage device 128 (e.g. one or more hard disk drives or redundant arrays of independent disks) for storing an operating system or other related software, and for storing application software programs such as any program related to the document analysis system 120. Examples of storage device 128 include, e.g., hard disk drive (HDD); optical drive including CD drive, DVD drive, or BLU-RAY drive; solid-state drive (SSD); USB flash drive; or any other device suitable for storing data. Some storage devices may include multiple volatile and non-volatile memories, including, e.g., solid state hybrid drives that combine hard disks with solid state cache. Some storage device 128 may be non-volatile, mutable, or read-only. Some storage device 128 may be internal and connect to the computing device 100 via a bus 150. Some storage device 128 may be external and connect to the computing device 100 via an I/O device 130 that provides an external bus. Some storage device 128 may connect to the computing device 100 via the network interface 118 over a network 104, including, e.g., the Remote Disk for MACBOOK AIR by Apple. Some client devices 100 may not require a non-volatile storage device 128 and may be thin clients or zero clients 102. Some storage device 128 may also be used as an installation device 116, and may be suitable for installing software and programs. Additionally, the operating system and the software can be run from a bootable medium, for example, a bootable CD, e.g. KNOPPIX, a bootable CD for GNU/Linux that is available as a GNU/Linux distribution from knoppix.net.

Client device 100 may also install software or application from an application distribution platform. Examples of application distribution platforms include the App Store for iOS provided by Apple, Inc., the Mac App Store provided by Apple, Inc., GOOGLE PLAY for Android OS provided by Google Inc., Chrome Webstore for CHROME OS provided by Google Inc., and Amazon Appstore for Android OS and KINDLE FIRE provided by Amazon.com, Inc. An application distribution platform may facilitate installation of software on a client device 102. An application distribution platform may include a repository of applications on a server 106 or a cloud 108, which the clients 102a-102n may access over a network 104. An application distribution platform may include application developed and provided by various developers. A user of a client device 102 may select, purchase and/or download an application via the application distribution platform.

Furthermore, the computing device 100 may include a network interface 118 to interface to the network 104 through a variety of connections including, but not limited to, standard telephone lines LAN or WAN links (e.g., 802.11, T1, T3, Gigabit Ethernet, Infiniband), broadband connections (e.g., ISDN, Frame Relay, ATM, Gigabit Ethernet, Ethernet-over-SONET, ADSL, VDSL, BPON, GPON, fiber optical including FiOS), wireless connections, or some combination of any or all of the above. Connections can be established using a variety of communication protocols (e.g., TCP/IP, Ethernet, ARCNET, SONET, SDH, Fiber Distributed Data Interface (FDDI), IEEE 802.11a/b/g/n/ac CDMA, GSM, WiMax and direct asynchronous connections). In one embodiment, the computing device 100 communicates with other computing devices 100′ via any type and/or form of gateway or tunneling protocol e.g. Secure Socket Layer (SSL) or Transport Layer Security (TLS), or the Citrix Gateway Protocol manufactured by Citrix Systems, Inc. of Ft. Lauderdale, Fla. The network interface 118 may comprise a built-in network adapter, network interface card, PCMCIA network card, EXPRESSCARD network card, card bus network adapter, wireless network adapter, USB network adapter, modem or any other device suitable for interfacing the computing device 100 to any type of network capable of communication and performing the operations described herein.

A computing device 100 of the sort depicted in FIGS. 1B and 1C may operate under the control of an operating system, which controls scheduling of tasks and access to system resources. The computing device 100 can be running any operating system such as any of the versions of the MICROSOFT WINDOWS operating systems, the different releases of the Unix and Linux operating systems, any version of the MAC OS for Macintosh computers, any embedded operating system, any real-time operating system, any open source operating system, any proprietary operating system, any operating systems for mobile computing devices, or any other operating system capable of running on the computing device and performing the operations described herein. Typical operating systems include, but are not limited to: WINDOWS 2000, WINDOWS Server 2012, WINDOWS CE, WINDOWS Phone, WINDOWS XP, WINDOWS VISTA, and WINDOWS 7, WINDOWS RT, and WINDOWS 8 all of which are manufactured by Microsoft Corporation of Redmond, Wash.; MAC OS and iOS, manufactured by Apple, Inc. of Cupertino, Calif.; and Linux, a freely-available operating system, e.g. Linux Mint distribution (“distro”) or Ubuntu, distributed by Canonical Ltd. of London, United Kingdom; or Unix or other Unix-like derivative operating systems; and Android, designed by Google, of Mountain View, Calif., among others. Some operating systems, including, e.g., the CHROME OS by Google, may be used on zero clients or thin clients, including, e.g., CHROMEBOOKS.

The computer system 100 can be any workstation, telephone, desktop computer, laptop or notebook computer, netbook, ULTRABOOK, tablet, server, handheld computer, mobile telephone, smartphone or other portable telecommunications device, media playing device, a gaming system, mobile computing device, or any other type and/or form of computing, telecommunications or media device that is capable of communication. The computer system 100 has sufficient processor power and memory capacity to perform the operations described herein. In some embodiments, the computing device 100 may have different processors, operating systems, and input devices consistent with the device. The Samsung GALAXY smartphones, e.g., operate under the control of Android operating system developed by Google, Inc. GALAXY smartphones receive input via a touch interface.

In some embodiments, the computing device 100 is a gaming system. For example, the computer system 100 may comprise a PLAYSTATION 3, a PLAYSTATION 4, PLAYSTATION 5, or PERSONAL PLAYSTATION PORTABLE (PSP), or a PLAYSTATION VITA device manufactured by the Sony Corporation of Tokyo, Japan, a NINTENDO DS, NINTENDO 3DS, NINTENDO WII, NINTENDO WII U, or a NINTENDO SWITCH device manufactured by Nintendo Co., Ltd., of Kyoto, Japan, an XBOX 360, an XBOX ONE, an XBOX ONE S, or an XBOX ONE S device manufactured by the Microsoft Corporation of Redmond, Wash.

In some embodiments, the computing device 100 is a digital audio player such as the Apple IPOD, IPOD Touch, and IPOD NANO lines of devices, manufactured by Apple Computer of Cupertino, Calif. Some digital audio players may have other functionality, including, e.g., a gaming system or any functionality made available by an application from a digital application distribution platform. For example, the IPOD Touch may access the Apple App Store. In some embodiments, the computing device 100 is a portable media player or digital audio player supporting file formats including, but not limited to, MP3, WAV, M4A/AAC, WMA Protected AAC, AIFF, Audible audiobook, Apple Lossless audio file formats and .mov, .m4v, and .mp4 MPEG-4 (H.264/MPEG-4 AVC) video file formats.

In some embodiments, the computing device 100 is a tablet e.g. the IPAD line of devices by Apple; GALAXY TAB family of devices by Samsung; or KINDLE FIRE, by Amazon.com, Inc. of Seattle, Wash. In other embodiments, the computing device 100 is an eBook reader, e.g. the KINDLE family of devices by Amazon.com, or NOOK family of devices by Barnes & Noble, Inc. of New York City, N.Y.

In some embodiments, the communications device 102 includes a combination of devices, e.g. a smartphone combined with a digital audio player or portable media player. For example, one of these embodiments is a smartphone, e.g. the IPHONE family of smartphones manufactured by Apple, Inc.; a Samsung GALAXY family of smartphones manufactured by Samsung, Inc.; or a Motorola DROID family of smartphones. In yet another embodiment, the communications device 102 is a laptop or desktop computer equipped with a web browser and a microphone and speaker system, e.g. a telephony headset. In these embodiments, the communications devices 102 are web-enabled and can receive and initiate phone calls. In some embodiments, a laptop or desktop computer is also equipped with a webcam or other video capture device that enables video chat and video call.

In some embodiments, the status of one or more machines 102, 106 in the network 104 is monitored, generally as part of network management. In one of these embodiments, the status of a machine may include an identification of load information (e.g., the number of processes on the machine, CPU and memory utilization), of port information (e.g., the number of available communication ports and the port addresses), or of session status (e.g., the duration and type of processes, and whether a process is active or idle). In another of these embodiments, this information may be identified by a plurality of metrics, and the plurality of metrics can be applied at least in part towards decisions in load distribution, network traffic management, and network failure recovery as well as any aspects of operations of the present solution described herein. Aspects of the operating environments and components described above will become apparent in the context of the systems and methods disclosed herein.

### B. Systems and Methods for Cloud-Based Invoice Analysis

The systems and methods of this technical solution for automated invoice document processing allow for the analysis of invoice data using cloud services. Client devices can interact with or transmit information to the systems described herein, which can function as layer or interface for cloud services and simplify the invoice extraction and analysis process. The extracted invoice data can then be provided to a node server, or can be posted into an enterprise resource planning (ERP) system, thus automatically creating an invoice that is ready to be processed while linking to the invoice image. The components of the systems and methods of this technical solution can be modular and adaptable to different operating environments.

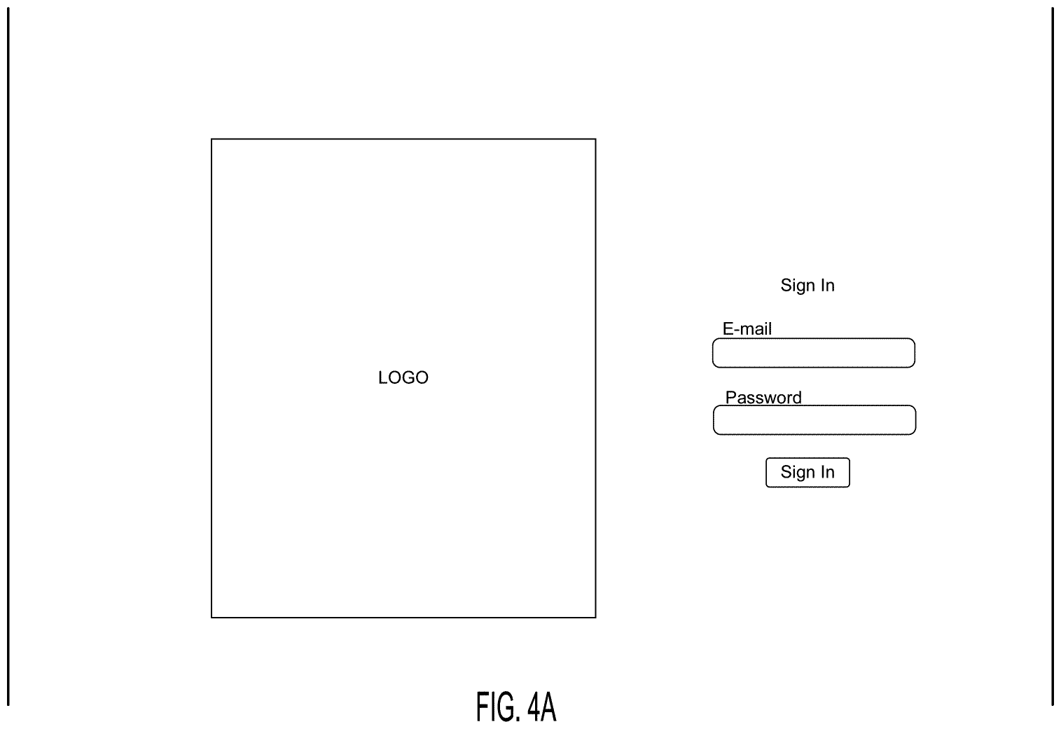

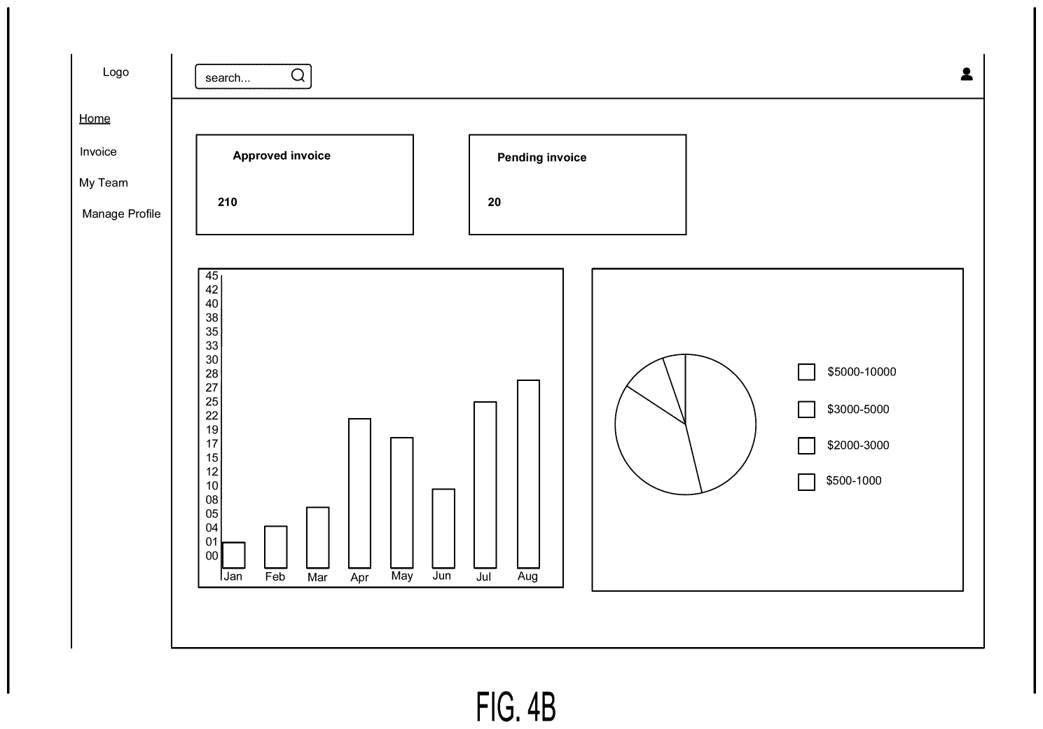

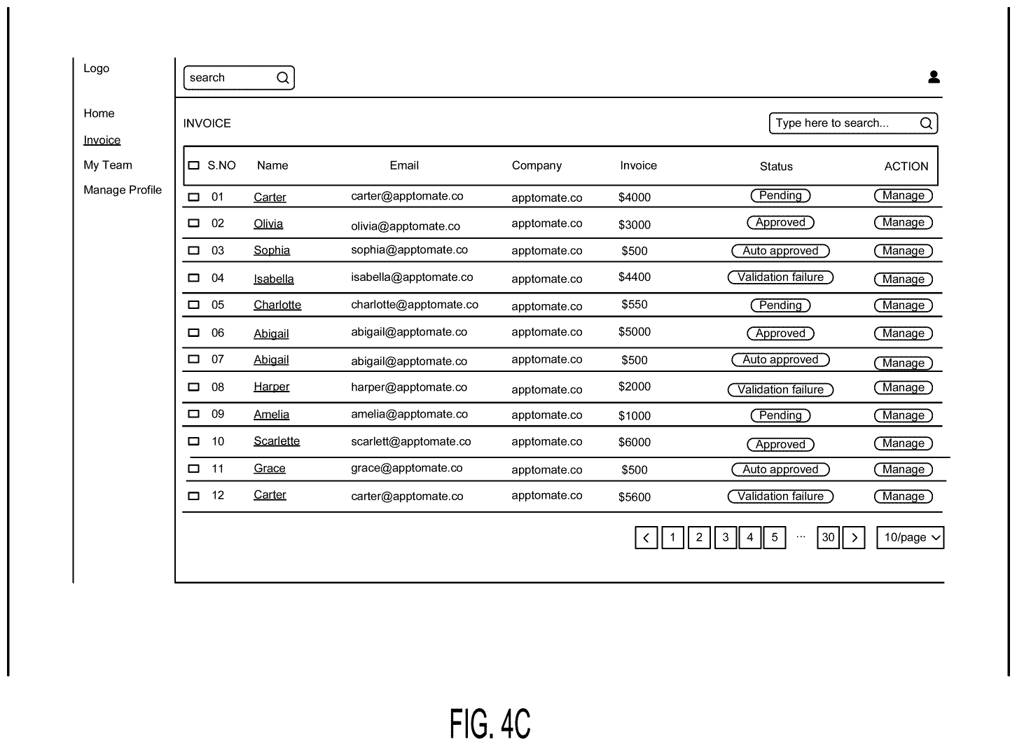

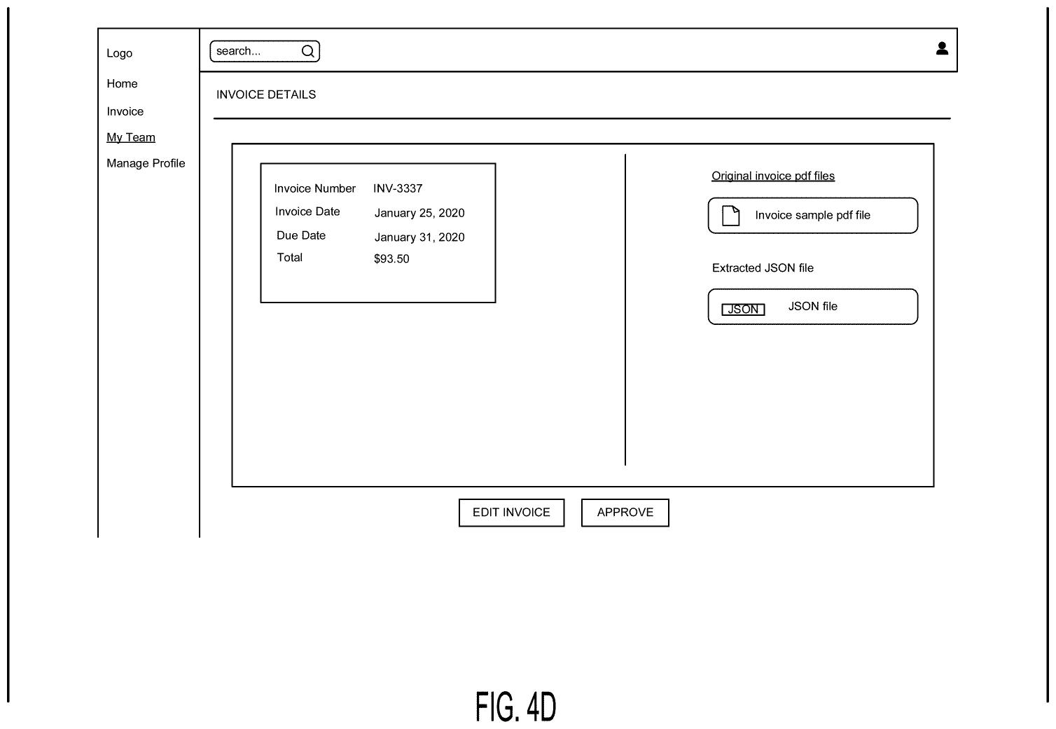

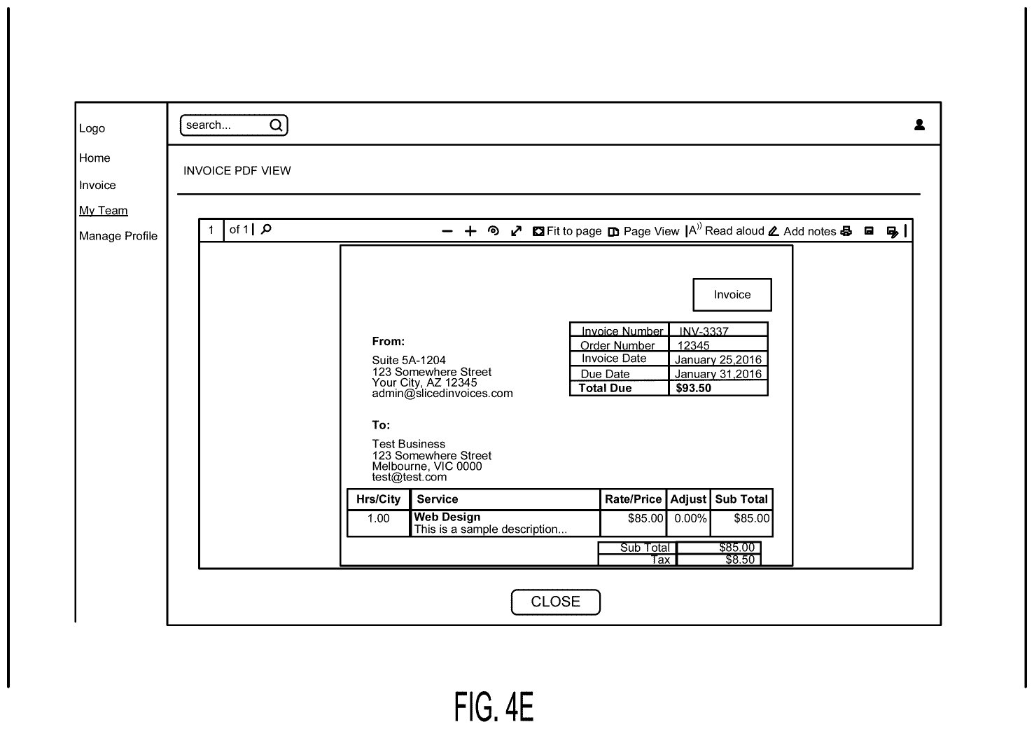

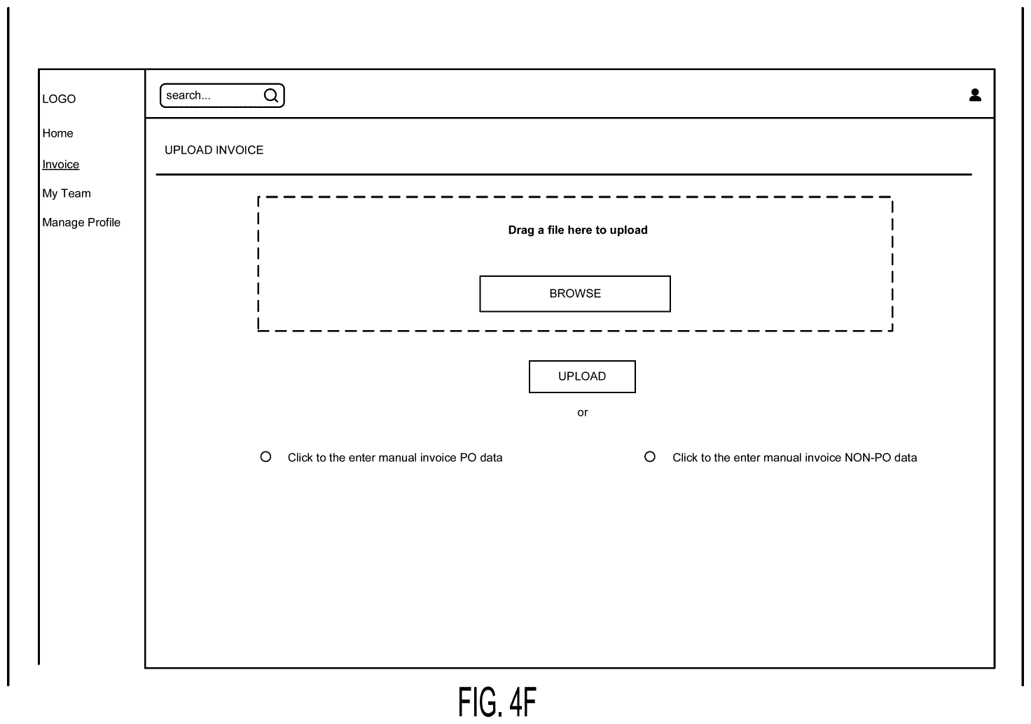

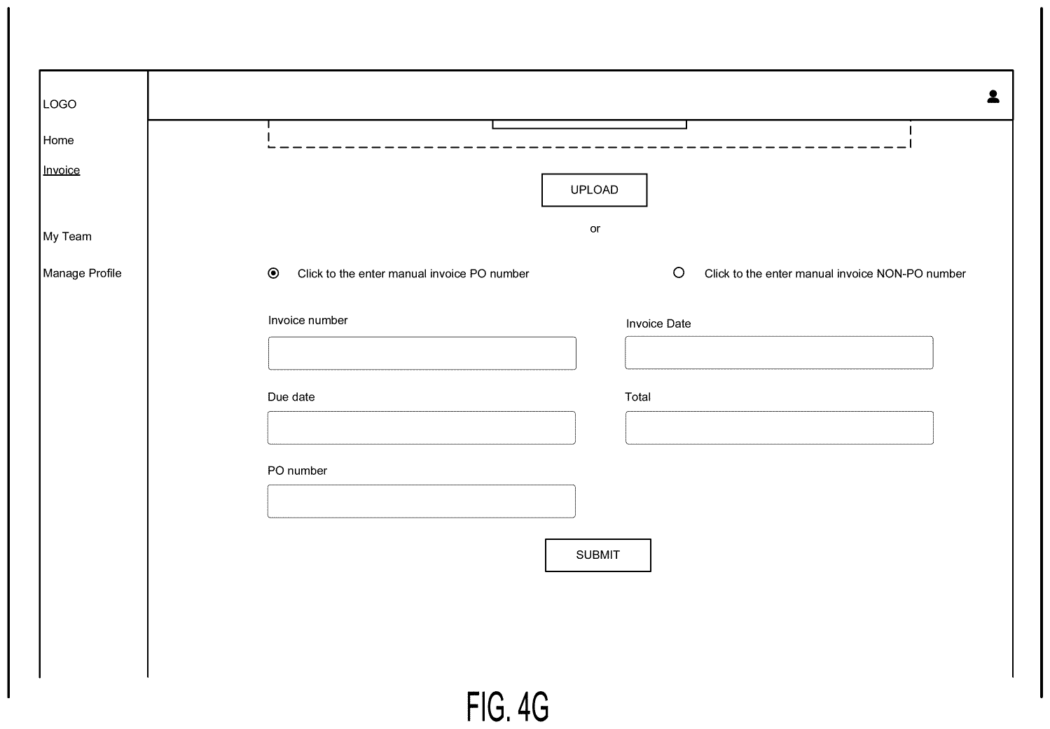

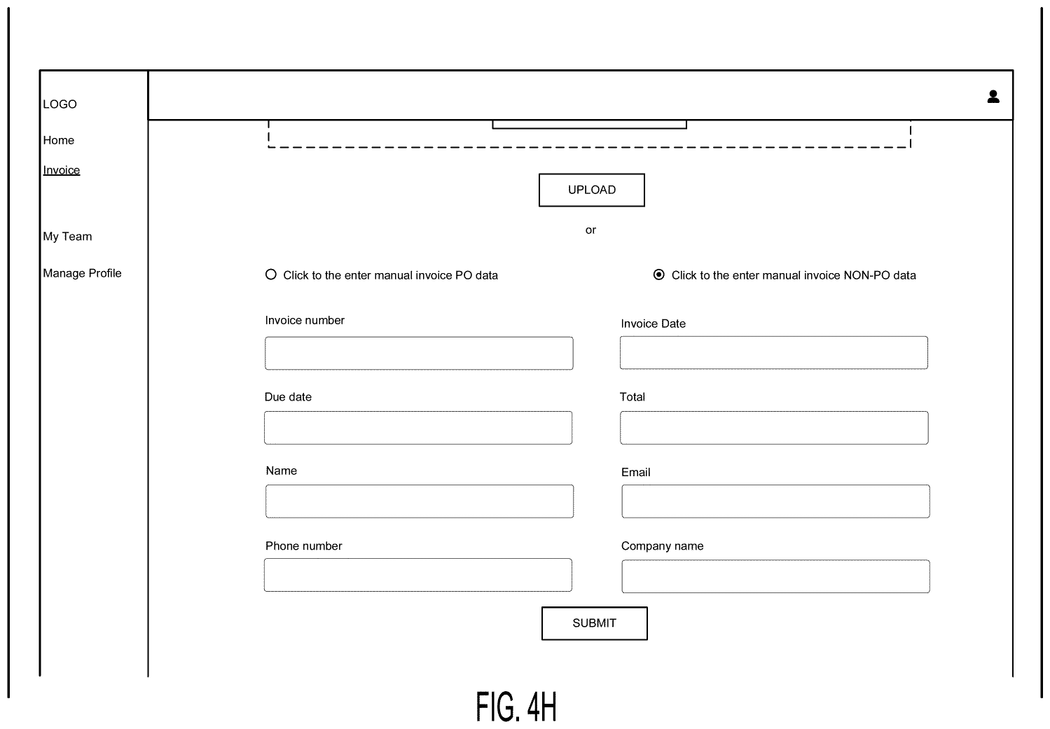

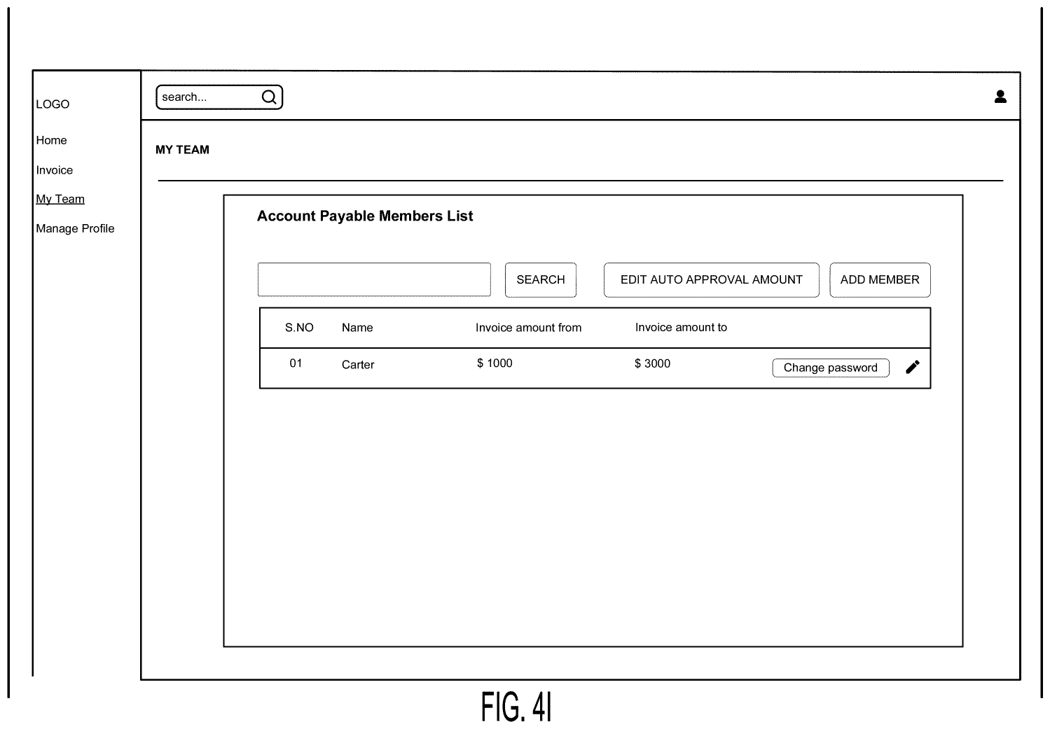

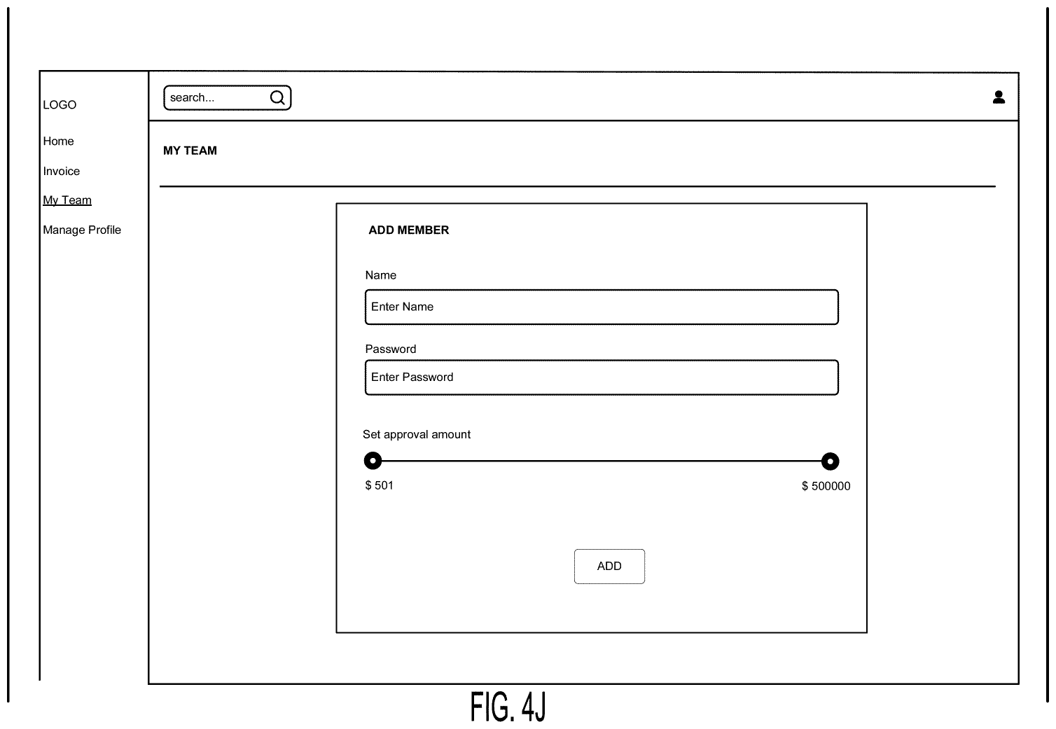

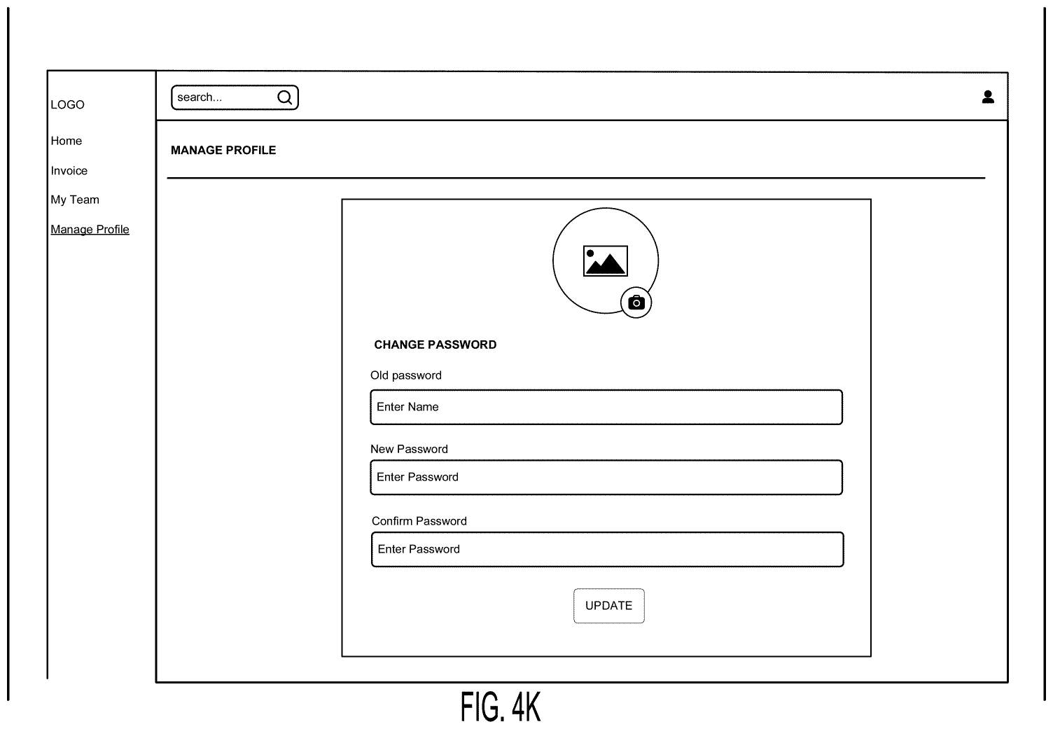

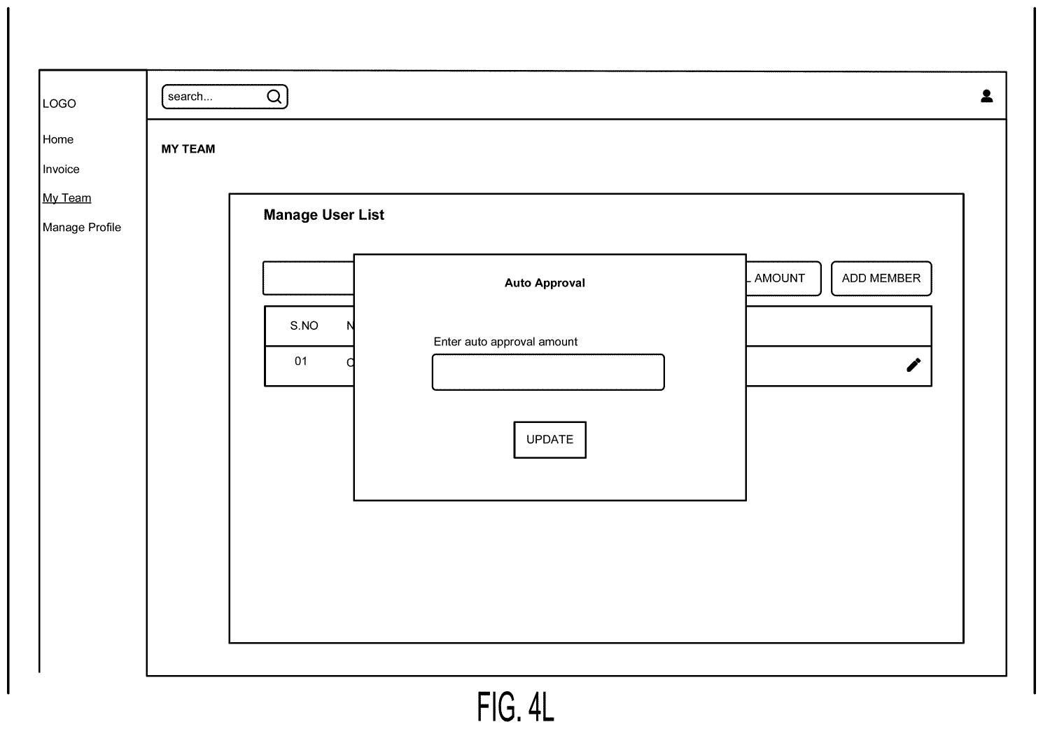

Another aspect of this disclosure is directed to providing a web-based user interface (UI), such as the web-based interface similar that depicted in FIGS. 4A-4L, that can connect a client device with controls and configuration settings that can modify or alter how the systems and methods process invoice document files. Access to the interface can be controlled by an account (e.g., with a username and password, a passkey, or other identifier, etc.) and role (e.g., each potential roll having permissions to modify one or more configurable aspects of the systems and methods, etc.). Thus, a client device can access the data, including invoices and any extracted invoice parameters that are specific to their user account. The invoice processing, approvals, and exception processing can be performed within the web-based application prior to any content or data being passed to the ERP integration adapters (e.g., with the exception of certain aspects, such as a purchase order (PO) number check, etc.). In addition, client devices responsible for managing the invoice processing can receive email notifications that prompt a device to take action on tasks presented in the emails or messages.

In addition, the systems and methods described herein provide techniques for training a classification model that classifies invoices as corresponding to particular suppliers. As described briefly above, supplier names or other supplier identifiers are often embedded within graphical logos or other non-standard formats. This is because, among other challenges, supplier names are not typically identified by a corresponding keyword. By utilizing a classification model to classify the supplier of an invoice prior to conducting the document extraction processes described herein, the systems and methods of this technical solution extend the functionality of conventional text processing techniques and improve the accuracy of invoice processing.

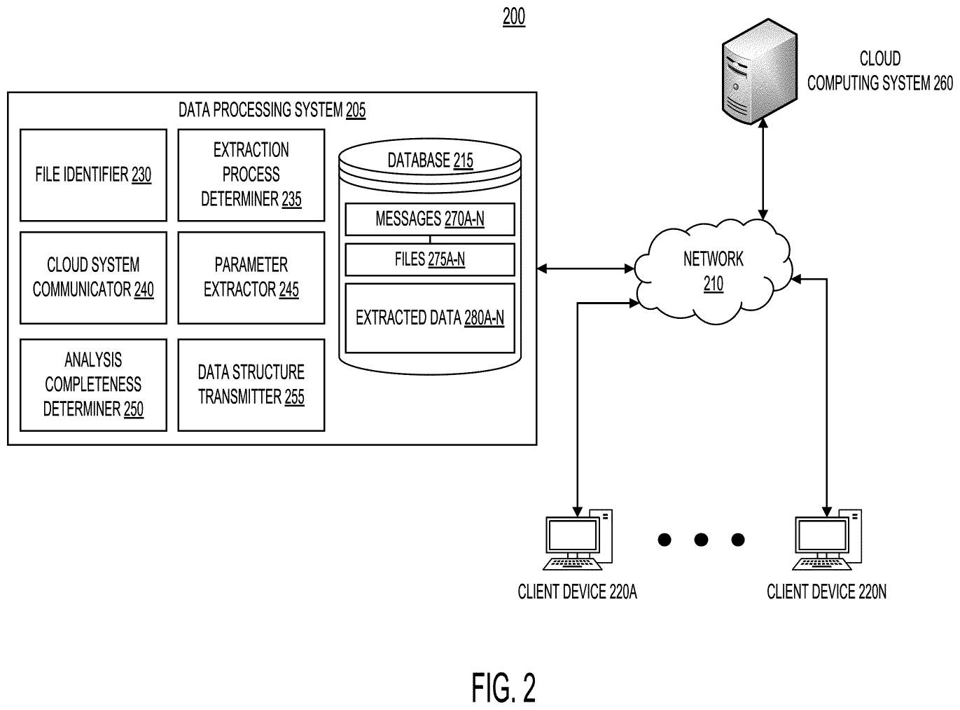

Referring now to FIG. 2, illustrated is a block diagram of an example system 200 for extracting parameters from invoices using a cloud computing system, in accordance with one or more implementations. The system 200 can include at least one data processing system 205, at least one network 210, at least one cloud computing system 260, and one or more client devices 220A-220N (sometimes generally referred to as client device(s) 220). The data processing system 205 can include at least one file identifier 230, at least one extraction process determiner 235, at least one cloud system communicator 240, at least one parameter extractor 245, at least one analysis completeness determiner 250, at least one data structure transmitter 255, and at least one database 215. The database 215 can include one or more messages 270A-270N (sometimes generally referred to as message(s) 270), one or more files 275A-275N (sometimes generally referred to as file(s) 275), and extracted data 280A-280N (sometimes generally referred to as extracted data 280). In some implementations, the database 215 can be external to the data processing system 205, for example forming a part of the cloud computing system 260 or an external computing device in communication with the devices (e.g., the data processing system 205, the cloud computing system 260, the client devices 220, etc.) of the system 200 via the network 210.

Each of the components (e.g., the data processing system 205, the network 210, the cloud computing system 260, the client devices 220, the file identifier 230, the extraction process determiner 235, the cloud system communicator 240, the parameter extractor 245, the analysis completeness determiner 250, the data structure transmitter 255, the database 215, etc.) of the system 200 can be implemented using the hardware components or a combination of software with the hardware components of a computing system (e.g., computing system 100, any other computing system described herein, etc.) detailed herein in conjunction with FIGS. 1A-1D. Each of the components of the data processing system 205 can perform the functionalities detailed herein.

The data processing system 205 can include at least one processor and a memory (e.g., a processing circuit). The memory can store processor-executable instructions that, when executed by a processor, cause the processor to perform one or more of the operations described herein. The processor may include a microprocessor, an application-specific integrated circuit (ASIC), a field-programmable gate array (FPGA), etc., or combinations thereof. The memory may include, but is not limited to, electronic, optical, magnetic, or any other storage or transmission device capable of providing the processor with program instructions. The memory may further include a floppy disk, CD-ROM, DVD, magnetic disk, memory chip, ASIC, FPGA, read-only memory (ROM), random-access memory (RAM), electrically erasable programmable ROM (EEPROM), erasable programmable ROM (EPROM), flash memory, optical media, or any other suitable memory from which the processor can read instructions. The instructions may include code from any suitable computer programming language. The data processing system 205 can include one or more computing devices or servers that can perform various functions as described herein. The data processing system 205 can include any or all of the components and perform any or all of the functions of the computer system 100 described herein in conjunction with FIGS. 1A-1D.

The network 210 can include computer networks such as the Internet, local, wide, metro or other area networks, intranets, satellite networks, other computer networks such as voice or data mobile phone communication networks, and combinations thereof. The data processing system 205 of the system 200 can communicate via the network 210, for instance with at least one cloud computing system 260. The network 210 may be any form of computer network that can relay information between the data processing system 205, the cloud computing system 260, one or more client devices 220, and one or more content sources, such as web servers, amongst others. In some implementations, the network 210 may include the Internet and/or other types of data networks, such as a local area network (LAN), a wide area network (WAN), a cellular network, a satellite network, or other types of data networks. The network 210 may also include any number of computing devices (e.g., computers, servers, routers, network switches, etc.) that are configured to receive and/or transmit data within the network 210. The network 210 may further include any number of hardwired and/or wireless connections. Any or all of the computing devices described herein (e.g., the data processing system 205, the computer system 100, etc.) may communicate wirelessly (e.g., via WiFi, cellular, radio, etc.) with a transceiver that is hardwired (e.g., via a fiber optic cable, a CAT5 cable, etc.) to other computing devices in the network 210. Any or all of the computing devices described herein (e.g., the data processing system 205, the computer system 100, etc.) may also communicate wirelessly with the computing devices of the network 210 via a proxy device (e.g., a router, network switch, or gateway). In some implementations, the network 210 can be similar to or can include the network 104 or the cloud 108 described herein above in conjunction with FIGS. 1A and 1B.

Each of the client devices 220 can include at least one processor and a memory (e.g., a processing circuit). The memory can store processor-executable instructions that, when executed by a processor, cause the processor to perform one or more of the operations described herein. The processor can include a microprocessor, an ASIC, an FPGA, etc., or combinations thereof. The memory can include, but is not limited to, electronic, optical, magnetic, or any other storage or transmission device capable of providing the processor with program instructions. The memory can further include a floppy disk, CD-ROM, DVD, magnetic disk, memory chip, ASIC, FPGA, ROM, RAM, EEPROM, EPROM, flash memory, optical media, or any other suitable memory from which the processor can read instructions. The instructions can include code from any suitable computer programming language. The client devices 220 can include one or more computing devices or servers that can perform various functions as described herein. The client devices 220 can include any or all of the components and perform any or all of the functions of the computer system 100 described herein in conjunction with FIGS. 1A-1D. The client devices 220 can be, or can be similar to, the client devices 102 described herein above in conjunction with FIGS. 1A-1D.

Each of the client devices 220 can be computing devices configured to communicate via the network 210 to access information resources, such as web pages via a web browser, or application resources via a native application executing on a client device 220. When accessing information resources, the client device can execute instructions (e.g., embedded in the native applications, in the information resources, etc.) that cause the client devices to display application interfaces, such as the web-based user interface described herein below in conjunction with FIGS. 4A-4L. In response to interaction with user interface elements, the devices 220 can transmit information, such as account information (e.g., changing account parameters, changing login information, etc.), invoice information (e.g., images or documents including invoice information, etc.), or other information that can configure the invoice processing systems described herein. In some implementations, a client device can transmit a request for an invoice document to be processed. The request can be an email message, a text message, a hypertext transfer protocol (HTTP) request message, a file transfer protocol message, or any other type of message that can be transmitted via the network 210. In some implementations, the request for document analysis can be in response to uploading a document via the user interface presented on the client device 220, for example the user interface displayed in FIG. 4F, where the webpage includes a script (e.g., JavaScript or a similar scripting language, etc.) that allows the client device 220 to upload a file to the data processing system 205 or to the cloud computing system 260 as a request for document analysis.

The cloud computing system 260 can include a computing device having at least one processor and a memory (e.g., a processing circuit). The memory can store processor-executable instructions that, when executed by processor, cause the processor to perform one or more of the operations described herein. The processor may include a microprocessor, an ASIC, an FPGA, etc., or combinations thereof. The memory may include, but is not limited to, electronic, optical, magnetic, or any other storage or transmission device capable of providing the processor with program instructions. The memory may further include a floppy disk, CD-ROM, DVD, magnetic disk, memory chip, ASIC, FPGA, ROM, RAM, EEPROM, EPROM, flash memory, optical media, or any other suitable memory from which the processor can read instructions. The instructions may include code from any suitable computer programming language. The cloud computing system 260 can include one or more computing devices or servers that can perform various functions as described herein. The cloud computing system can be, or can be similar to, the cloud 108 described herein above in conjunction with FIGS. 1A-1D.

The cloud computing system 260 can receive, store or maintain, and process documents (e.g., files, etc.), such as documents in the portable document format (PDF) or in an image format. Image formats can include JPEG, JPEG 2000, EXIF, TIFF, GIF, BMP, PNG, RAW, SVG, or any other type of image format. The cloud computing system 260 can receive one or more documents in the form of one or more messages via the network 210. For example, the cloud computing system 260 can receive (e.g., and store the contents of, etc.) messages transmitted by the client computing device to process an invoice document. In some implementations, the requests transmitted by the client devices 220 can be directed to the data processing system 205, which can then forward the file and any relevant information to the cloud computing system 260 for processing, as described herein. In some implementations, the data processing system 205 can form a portion of the cloud computing system 260, along with a portion of the network 210.

The cloud computing system 260 can implement a text extraction platform that can detect and analyze text in documents such as PDF files or image files. The text extraction platform can be configured using instructions, such as the instructions provided by the data processing system 205, as described herein. The text extraction can be an asynchronous process that can process documents having multiple pages, such as multipage invoice documents. The asynchronous process can take documents having predetermined file types as input, for example PDF files, PNG images, or JPG images. The text extraction process can be implemented using machine learning, for example a neural network, a recurrent neural network, a natural language processing (NLP) algorithm, or other types of detection or classification models. In some implementations, the text extraction process can identify and extract lines of text in a document. One such example of a text extraction platform can be the Textract application programming interface (API), provided by Amazon.com, Inc., of Seattle, Wash., as part of their AMAZON WEB SERVICES platform.

The text processing platform implemented by the cloud computing system 260 can take an invoice document as input, and return one or more data structures that include pages, lines, and word objects. The data structures can be similar to lists or arrays in the Python programming language. In some implementations, the one or more objects can be provided in a hierarchical data format, such as a JavaScript Object Notation (JSON) format. For example, each page in the processed document can be represented as a block data structure of text, which can contain one or more line objects containing one or more word objects. This information can be structured such that it is stored in a similar arrangement to how the text is formatted on the analyzed page. For example, text at the top left of the document can be stored in the first entries of the data structures, while text at the bottom right of the document can be stored in the final entries of the data structures. The cloud computing system can provide a status message (e.g., to a computing device that requested the status of the document processing operation for an identified document, etc.) that indicates whether the document processing is in progress, has completed, or has failed. The cloud computing system 260 can transmit the data structures including text extracted from the document to the data processing system 205, for example in response to a request for the extracted information. An example of a portion of a JSON file that includes text information extracted from an invoice file is included below:

```
{
  ″BlockType″: ″LINE″,
  ″Confidence″: 99.67257690429688,
  ″Text″: ″$2000.00″,
  ″Geometry″: {
    ″BoundingBox″: {
      ″Width″: 0.07525761425495148,
      ″Height″: 0.013138916343450546,
      ″Left″: 0.7218055725097656,
      ″Top″: 0.5026268362998962
    },
    ″Polygon″: [
      {
        ″X″: 0.7218055725097656,
        ″Y″: 0.5026268362998962
      },
      {
        ″X″: 0.7970631718635559,
        ″Y″: 0.5026268362998962
      },
      {
        ″X″: 0.7970631718635559,
        ″Y″: 0.5157657265663147
      {,
      }
        ″X″: 0.7218055725097656,
        ″Y″: 0.5157657265663147
      }
    ]
  },
  ″Id″: ″b0a05cb1-b234-4b4b-8c12-7beeb8e38418″,
  ″Relationships″: [
    {
      ″Type″: ″CHILD″,
      ″Ids″: [
        ″742b6bdf-af31-40f9-96b2-a9203ae65774″
      ]
    }
  ],
  ″Page″: 1,
  ″childText″: ″$2000.00 ″,
  ″SearchKey″: ″$2000.00″
},
```

Alternatively, the text processing platform implemented by the cloud computing system 260 may be a synchronous text processing algorithm, which may, in some circumstances, have lower latency than the asynchronous text extraction process described herein above. However, the synchronous operation may operate on, or have greater accuracy or performance than, the asynchronous text extraction process when utilized on different file types. For example, the synchronous text extraction process may take as input documents with different predetermined file types, such as PNG images or JPG images, or single-page documents. These images can include text that is extracted using a machine-learning algorithm, such as a neural network, a recurrent neural network, a convolutional neural network, a classification model, a natural language processing algorithm, or other type of text extraction algorithm. The output of the synchronous text extraction process can be one or more data structures having a similar structure to those output from the asynchronous operation, including blocks representing pages having one or more line objects (e.g., lines of text as they appear in the document, etc.) with one or more word objects (e.g., words as they appear in the document, but encoded in ASCII or UNICODE format, etc.). In some implementations, the data structures can be provided in a hierarchical data format, such as a JSON format. In some implementations, the data structures can be generated in a hierarchical data format, such as a JSON format. Once generated, the data structures output from the synchronous text extraction process can be transmitted to the data processing system 205 via the network 210 for further processing, as described herein.

The database 215 can be a database configured to store and/or maintain any of the information described herein. The database 215 can maintain one or more data structures, which may contain, index, or otherwise store each of the values, pluralities, sets, variables, vectors, or thresholds described herein. The database 215 can be accessed using one or more memory addresses, index values, or identifiers of any item, structure, or region maintained in the database 215. The database 215 can be accessed by the components of the data processing system 205, or any other computing device described herein, via the network 210. In some implementations, the database 215 can be internal to the data processing system 205. In some implementations, the database 215 can exist external to the data processing system 205, and may be accessed via the network 210. The database 215 can be distributed across many different computer systems or storage elements, and may be accessed via the network 210 or a suitable computer bus interface. The data processing system 205 can store, in one or more regions of the memory of the data processing system 205, or in the database 215, the results of any or all computations, determinations, selections, identifications, generations, constructions, or calculations in one or more data structures indexed or identified with appropriate values. Any or all values stored in the database 215 may be accessed by any computing device described herein, such as the data processing system 205, to perform any of the functionalities or functions described herein. In some implementations, the database 215 can be similar to or include the storage 128 described herein above in conjunction with FIG. 1C. In some implementations, instead of being internal to the data processing system 205, the database 215 can form a part of the cloud computing system 260. In such implementations, the database 215 can be a distributed storage medium in the cloud computing system 260, and can be accessed by any of the components of the data processing system 205, by the one or more client devices 220 (e.g., via the user interface similar to that depicted in FIGS. 4A-4L, etc.), or any other computing devices described herein.

The database 215 can store one or more messages 270 received from client devices 220. The messages can include invoice information, such as invoice documents or files, such as PDF files or image files (e.g., JPEG, JPEG 2000, EXIF, TIFF, GIF, BMP, PNG, RAW, SVG, etc.). The messages, and any files or documents associated with said messages, can be identified by an identifier of their storage location in the database 215. Said information can be accessed by the computing devices of the system 200 using the identifier associated with the respective messages 270. The messages 270 can be email messages, text messages, hypertext transfer protocol (HTTP) request messages, file transfer protocol messages, or any other type of message that can be transmitted via the network 210. The database 215 can store the messages 270 in association with the files 275, which can be included in and extracted from respective messages 270. The messages can identify an account of one or more client devices that access the data processing system 205. The account identifier can be stored in association with one or more configuration settings, such as access permissions for the messages 270, the files 275, and the extracted data 280. The account identifier can be stored in association with a storage location of the results of invoice file analysis processes, such as those performed on files received in messages associated with the account identifier. The account identifier may correspond to an organization that subscribes to the services of the data processing system 205.

The database 215 can store or maintain one or more files 275 associated with the messages. The files can be identified by a file identifier, and can have a file format that describes how the information in the file is stored. For example, different image formats store similar visual data, but in different formats or representations. A file format can describe the structure of the information contained within the file. File formats can be identified by an extension, or by analyzing a predetermined region of the contents of the file. Certain file formats include a header region at the start of the file that describes various characteristics of the file, including the format, and any parameters of the file that are specific to that format. The locations of these aspects can be predetermined, or determined by analyzing the header of the file. The data processing system 205 (or any of the components thereof) can extract a file from a message as it is received, and can store the file in association with said message in one or more data structures in the database 215. The location of each file 275 in the database 215 can be identified by a file identifier, which can be used to retrieve or modify the contents of the file.

Although the techniques described herein include implementations that can extract information from invoices, it should be understood that the techniques described herein can be applied to any type of document to extract any type of information. For example, the techniques described herein are applicable to general data entry tasks, in which predetermined types of information are extracted from any type of document. As such, terms such as “invoice file” and “invoice parameters” should be understood as examples, rather than as limiting the scope of the document processing techniques described herein.

Referring now to the operations of the data processing system 205, the file identifier 230 can identify an invoice file having a file type that was extracted from a message. In some implementations, identifying a file can include receiving a request for document analysis from a client device 220. As described herein above, a request can be an email message, a text message, a HTTP request message, a file transfer protocol message, or any other type of message that can be transmitted via the network 210. The message can include one or more files, which can be invoice documents. For example, if the request is an email message 270, the one or more files can be identified in the email message as attachments. The attachments can be files that represent invoices, for example a PDF file of an invoice or an image of an invoice. An invoice can include invoice parameters, such as an invoice identifier, a purchase order (PO) number, an invoice amount, or an invoiced due date, among others. Each file can be stored in one or more data structures in the database 215 as the files 275, and can be identified with a corresponding file location identifier. The file location identifier can be used as an input to a text extraction process, such as the text extraction processes performed by the cloud computing system 260, as described herein. In some implementations, a file 275 may be received from a message 270 received from a supplier. In such implementations, the email address (or the email domain of the email address) of the sender may be used to determine which supplier is associated with the corresponding invoice file 275.

The extraction process determiner 235 can determine an extraction process for the invoice file based on the file type. To extract the text information from the invoice file identified by the file identifier 230, the extraction process determiner 235 can leverage the computing power of a cloud computing system, such as the cloud computing system 260. The extraction process can extract text data in the file, which may be encoded as a visual representation of text, and produce one or more data structures including text that is usable for further processing, such as text encoded in ASCII or UNICODE format. As the cloud computing system 260 can implement many different text extraction processes, the extraction process determiner 235 can determine which of said text extraction processes are appropriate to analyze the identified invoice file. One way the extraction process determiner 235 can determine the extraction is based on the file type of the invoice file. As different extraction processes may be used to process different types of files, the file type can be used to determine which extraction process is appropriate to extract text from the file. To determine the file type of the identified invoice file, the extraction process determiner 235 can identify a file extension of the file. In some implementations, the extraction process determiner 235 can analyze one or more predetermined regions in the file, such as the file header, to identify one or more predetermined values that indicate file type. If the identified file is a PDF file, the extraction process determiner 235 can select an asynchronous extraction process provided by the cloud computing system 260. If the identified file is a PNG or a JPG file, the extraction process determiner 235 can select a synchronous extraction process provided by the cloud computing system 260.

In the event that the extraction process determiner 235 cannot identify a file type for the invoice file, or the file type of the invoice file is not a PDF, JPG, or PNG file, the extraction process determiner 235 can flag the file as unrecognized. Flagging the file as unrecognized can include storing one or more values in the database 215 with the invoice file 275 that indicates the invoice file 275 cannot be recognized or processed. In some implementations, if the file format is a related image format, such as another image file type (e.g., JPEG 2000, EXIF, TIFF, GIF, BMP, RAW, SVG, etc.), the extraction process determiner 235 can convert the file into one of a PDF, a JPG, or a PNG file. The extraction process determiner 235 can perform said conversion using one or more image conversion techniques. The resulting converted file can be stored in association with the respective invoice file 275 in one or more data structures in the database 215. The converted file can be stored with its own file location identifier, which can be used in the text extraction process provided by the cloud computing system 260. Once the invoice file 275 has been converted to an appropriate format, the extraction process determiner 235 can determine the appropriate extraction process based on the file type of the converted file, and utilize the converted file in place of the invoice file 275 in further operations (e.g., text extraction and invoice analysis, etc.).

After the extraction process has been determined for the one or more files 275 by the extraction process determiner 235, the cloud system communicator 240 can generate and transmit instructions to the cloud computing system 260 to carry out the text extraction process. The instructions can be in any suitable language, for example JavaScript or Python instructions. The instructions can indicate the name of the file 275 and the location identifier of the file. The location identifier of the file can be, for example, a 64-bit integer that is unique to the file 275 to be analyzed using the determined text extraction process. The instructions can include an identification of the text extraction process to be performed on the file (e.g., the synchronous or asynchronous version, etc.). For example, in an asynchronous Textract extraction process performed on a PDF file, the cloud system communicator 240 can generate instructions to include the GetDocumentTextDetection function of the Textract API. Likewise, for a synchronous Textract extraction process performed on a PNG or a JPG file, the cloud system communicator 240 can generate instructions to include the DetectDocumentText function of the Textract API.

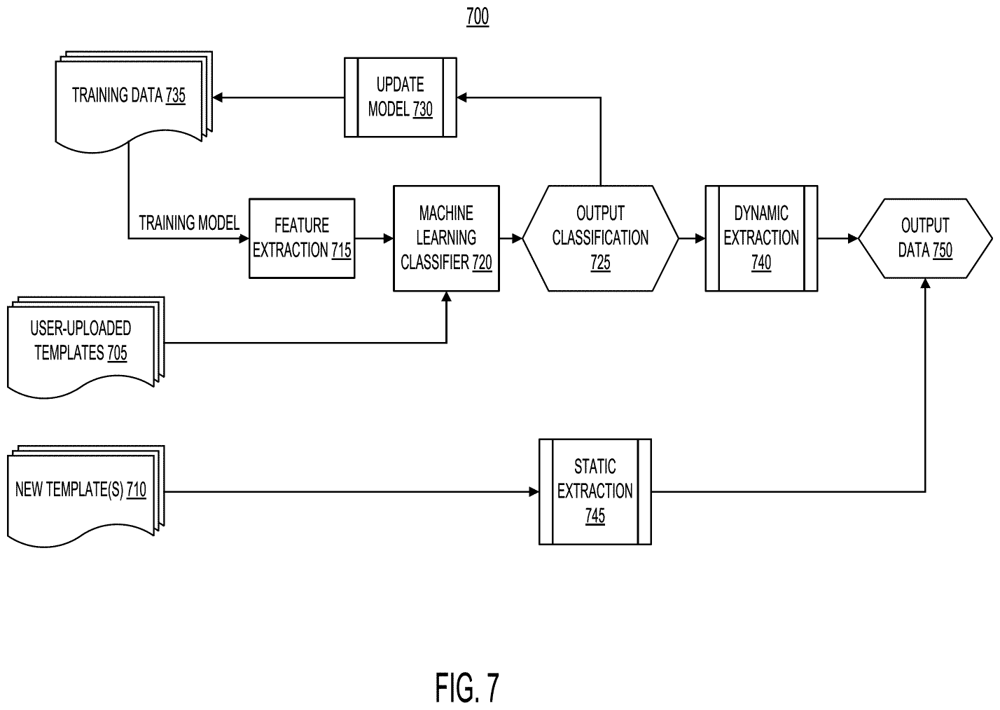

In some implementations, the cloud system communicator 240 can identify a supplier of the file 275 (e.g., the name of the organization or company to which the payment on the invoice is due). To do so, the cloud system communicator 240 may perform operations similar to those described in connection with FIG. 7. In some implementations, the operations described in connection with FIG. 7 are performed by one or more servers of the cloud computing system 260. In such implementations, cloud system communicator 240 may generate instructions to the cloud computing system 260 to perform a supplier classification process. The instructions may include the file 275 and an account identifier of the organization accessing the functionality of the data processing system 205. After performing the supplier classification operations described in connection with FIG. 7, the cloud system communicator 240 generates (or receives from the cloud computing system 260) a classification of the supplier of the file 275. The instructions that are transmitted to the cloud computing system 260 to perform the extraction process may include the classification of the supplier of the file 275.

After transmitting the instructions to the cloud computing system 260, the data processing system 205 can receive a response message with an identifier of the extraction process for that particular file. The identifier of the extraction process can be used to query the status of the extraction process as it is performed by the cloud computing system 260. The cloud system communicator 240 can query the cloud computing system 260 until the process has completed, and receives either a success or a failure message.

Once the status indicates a success message, the cloud system communicator 240 can transmit a request to access the results of the extraction process to the cloud computing system 260. The request to access the results of the extraction process can include the identifier of the extraction process provided by the cloud computing system 260. In response, the cloud system communicator 240 can receive a response message that includes one or more objects that are extracted from the invoice file. As described herein above, the one or more objects can be text objects that stored in a hierarchical format, such as a JSON format. For example, each page in the processed invoice file can be represented as a block object, which can contain one or more line objects containing one or more word objects. The output of a Textract process creates a box (e.g., an identified region of the file 275) with coordinates around each string of unbroken text within the file 275 (e.g., as one or more line or word objects in a hierarchy). These objects are provided as output in a JSON data structure, which includes the pieces of encompassed text and a confidence rating (e.g., which indicates a relative confidence that the text recognition is accurate for the particular segment of text). The objects can include data structures that include pointers or identifiers to other data structures lower in the hierarchy. A block can contain a list of pointers to line objects, and each line object can include a list of points to word objects, which contain the text information. The word objects can include text information for a single extracted word in an encoded format, for example ASCII or UNICODE. The data structures storing the text information can be structured in a similar arrangement to how the text would appear in a rendering of the analyzed document. For example, text at the top left of the document can be stored in the first entries of the data structures, while text at the bottom right of the document can be stored in the final entries of the data structures. If the status indicates that the text extraction process was not successful, the components of the data processing system 205 can perform a backup extraction process, as described herein below in conjunction with the parameter extractor 245.

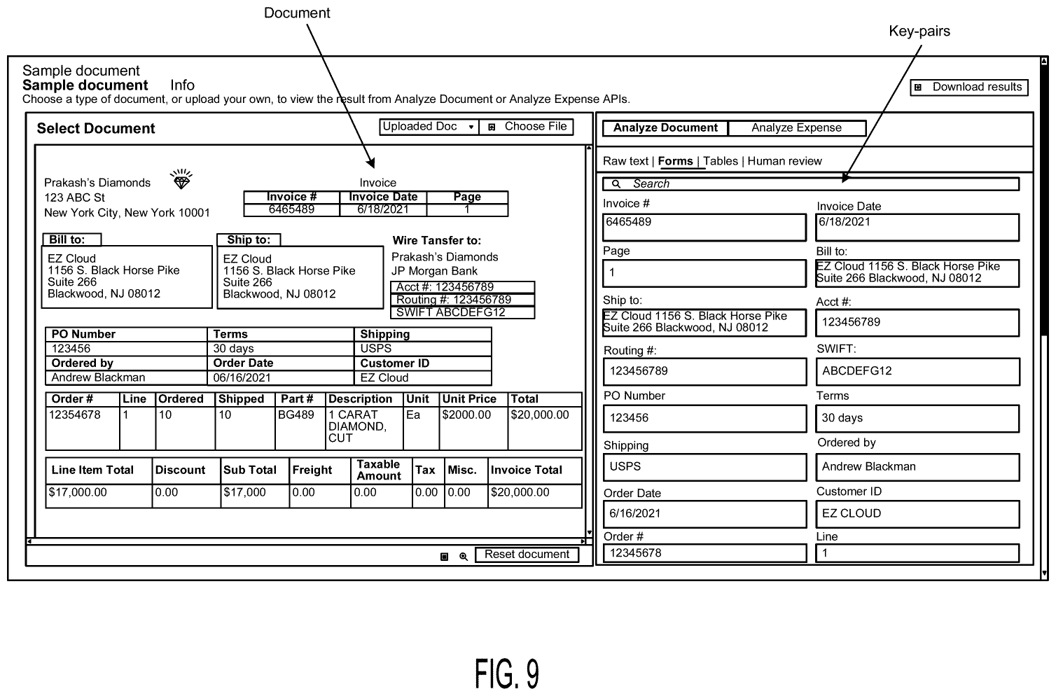

After receiving the data structures containing the text extracted from the invoice file 275 using the text extraction process, the parameter extractor 245 can extract predetermined invoice parameters from the one or more objects using a first analysis process. The predetermined invoice parameters can be values that are required to correctly process an invoice. For example, the invoice parameters can include an invoice identifier, a PO number, an invoice amount, or an invoiced due date, among others. The first analysis process can include a traverse-based rule extraction process (sometimes referred to herein as a “keyword pairs analysis” or a “key-pair value” analysis). As invoices are designed to be human readable, the desired invoice parameters are typically proximate to an identifier of the particular parameter. For example, an invoice identifier may be preceded by, or close to, the text “Invoice ID:” on a document. To identify a particular parameter, the parameter extractor 245 can traverse, or iterate through, each of the parameters or sequences of line objects and word objects to identify and extract the requested parameters that are proximate to predetermined sets of keywords. FIG. 9 shows an example output of one or more key-pairs (parameters that correspond to one or more keywords), identified using the techniques described herein.

The keyword pairs extraction process can be implemented as an iterative searching algorithm that identifies matching keywords in the word objects received by the cloud system communicator 240. The keywords with which the word objects are matched can be stored in one or more data structures in the memory of the data processing system 205. The keywords can be updated by one or more update messages received from one or more external computing devices via the network 210. The parameter extractor 245 can traverse the word objects extracted from the invoice document and compare the information in the word objects to one or more keywords. When a matching keyword is identified in a word object, other word objects that are proximate to the matching word object can be searched to extract one or more invoice parameters. The parameter extractor 245 can identify one or more parameters that are stored in proximate (e.g., in the block objects of the invoice document, etc.) word objects or in proximate line objects based on one or more rules. For example, if an “Invoice ID” keyword is identified, the parameter extractor 245 can access word objects representing text that would have appeared on the document to the right of the identified keyword or underneath the identified keyword. If the text in one of those word objects matches certain criteria (e.g., having an invoice identifier prefix, being an alphanumeric string, having a certain number of characters, etc.), the parameter extractor 245 can extract that word object as an invoice identifier parameter for the invoice document.

Thus, the traversal algorithm can be rule based, and the parameter extractor 245 can compare portions of each line object or word object to one or more keywords, conditions, or rules. If a rule is satisfied for a particular invoice parameter, the rule can return or provide an identifier for the location in the one or more line objects or word objects for the invoice parameter. To extract the data, the parameter extractor 245 can access the one or more line objects or word objects and extract the encoded text data from the location identified by the rule. Extracting the text data can include copying the desired text data into a different region of memory, for example one or more data structure containing the invoice parameters for the invoice file 275 under analysis. However, occasionally the first analysis process using the traversal algorithm may fail to extract all of the desired invoice parameters. The desired invoice parameters can be specified by the client device 220 that provided the messages including the invoice file, or by a client device 220 setting a configuration setting for the data processing system 205.

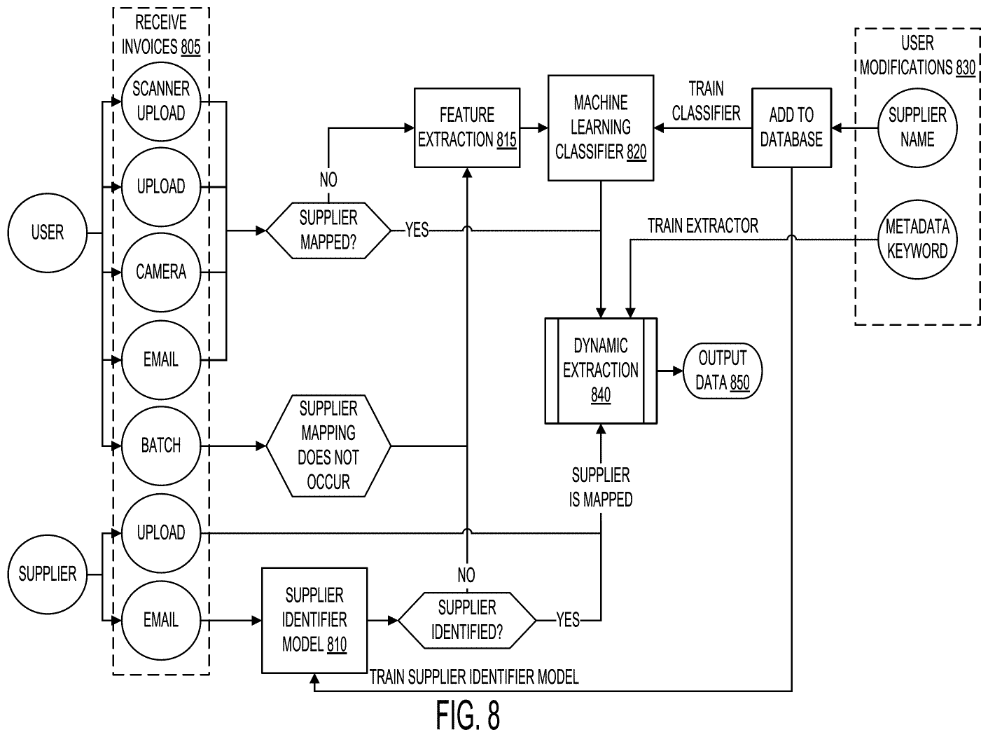

The parameter extractor 245 can perform analysis on the information extracted from the invoice files using a variety of techniques. For example, the parameter extractor 245 can access the key pair values in the JSON files or other data structures provided as an output of the extraction process. For example, certain key pair values can correspond to desired invoice information, such as the amount due, amount paid, invoice mailing date, or invoice due date, among others. The key pair values may be matched to information in one or more lookup tables that includes desired information to be extracted from invoice files. In some implementations, the key pair values can be identified based on the supplier of the invoice (e.g., the supplier name determined using processes described in connection with FIGS. 7 and 8). Users of the data processing system 205 may update the tables of key values associated with different suppliers via one or more user interfaces provided by the data processing system 205. For example, the data processing system 205 may provide a web-based interface that includes interactive user interface elements that can receive key values for different suppliers. The key values can be stored in one or more data structures in the database 215.

In some implementations, the parameter extractor 245 engine can perform both horizontal and vertical analysis (e.g., an “X and Y” analysis) to extract the parameters from the text file. The horizontal and vertical analysis can operate by scanning text information based on the coordinates indicated in the data structures retrieved from the cloud computing system 260. The parameter extractor can iterate through each word (or other text object) and scan information extracted from the file 275 in both the horizontal (e.g., left and right) and vertical (e.g., up and down) to identify key values (which may be predetermined) that may assist in identifying the relevant metadata for each desired field (e.g., invoice amount, due date, etc.). The actual value extracted may be any value that is adjacent (horizontally on the x-axis or vertically on the y-axis) to any text identified as matching the criteria. Each portion of unbroken text extracted from the file can include four coordinates that encompass the piece of text (e.g., defining a bounding region). The position-based analysis (e.g., either vertical or horizontal) can be performed to search for predetermined keywords (e.g., which may be default keywords or may correspond to the supplier of the file). Then, text appearing in the document within a predetermined distance of the predetermined keywords is searched to attempt to locate metadata that would fit the attributes of the metadata field. For example, the metadata can be a dollar amount if an “Amount Due” is located as keywords in the file. These processes may be performed in both the vertical and horizontal directions across the file, using the position data returned from the extraction process. Additional programmatic filters, which may be predetermined or selected based on the supplier of the file 275, may be used to filter the data based on upon the type of parameter being extracted if multiple adjacent pieces of text are located. For example, if a particular value is numerical only, such as a dollar amount, parameter filters may ignore any text showing an alphabetical character.

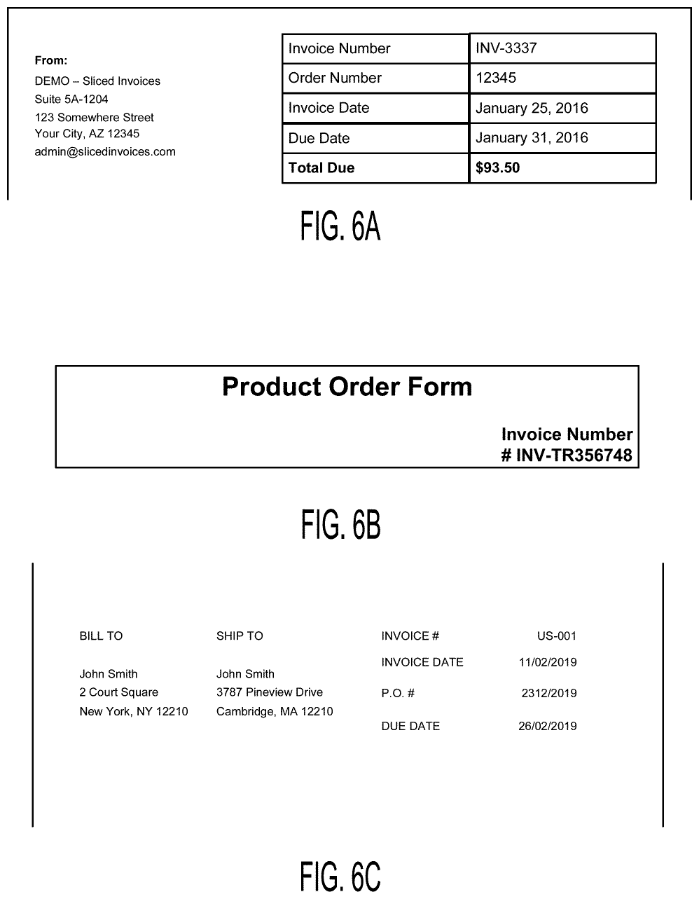

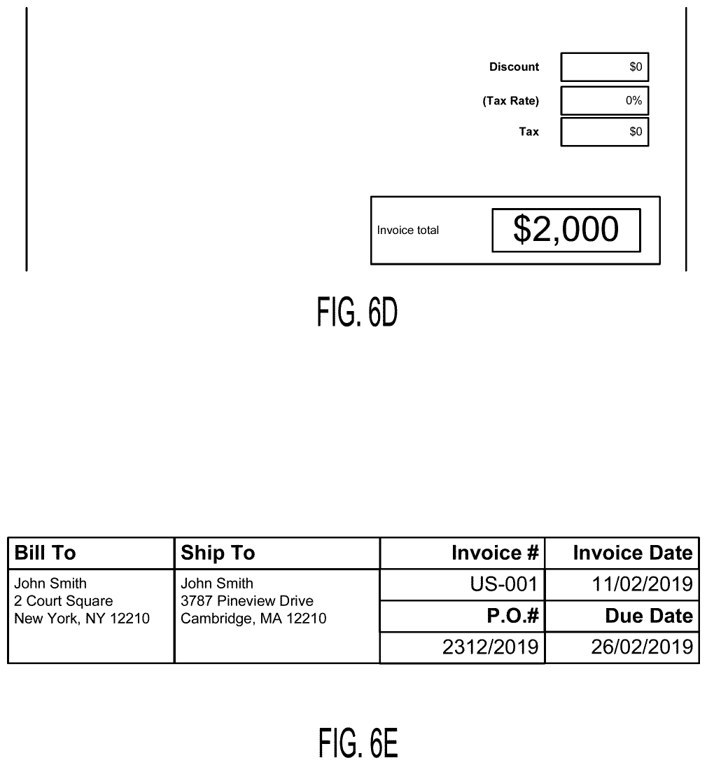

By identifying the supplier, extraction processes may be implemented and tailored for each individual supplier. Invoice parameters that are extracted by the parameter extraction processes performed by the parameter extractor 245 can be stored in one or more databases or regions of memory in the data processing system 205, and can include particular values for each individual supplier identified using the techniques described herein. For example, the account identifier used to access the functionality of the data processing system 205 can be stored in association with a list of supplier identifiers (e.g., the suppliers that communicate invoice documents to the organization corresponding to the account identifier). These supplier-specific values or fields can be modified by accessing the database via one or more applications (e.g., a web-based user interface, a native application, etc.). For example, a client device 220 may access and modify the stored supplier-specific values or fields by accessing a web-based interface provided by the data processing system 205. For example, the values or fields can be identified as information that appears adjacent to an identified parameter in a file 275 provided by a particular supplier. To extract supplier-specific fields, supplier specific rules may be used. For example, each of the extraction processes described in connection with FIGS. 6A-6E may be associated with a different supplier. These values or fields in the database can then be accessed by the parameter extractor 245 to identify and extract the associated parameters.

The extracted invoice parameter values can be stored in the database 215 as the extracted data 280, which can be stored in association with the file 275 from which the extracted data 280 was extracted. The extracted data 280 can include the invoice parameters, and other information about the invoice, such as the source of the invoice, the account identifier associated with the invoice (e.g. the account that transmitted the invoice to the data processing system 205, etc.), among others. The extracted data 280 can be accessed by other computing devices of the system 200, such as the client devices 220. For example, if the client device 220 accesses the web-based user interface provided by the data processing system 205 using an account identifier, the client device 220 can access the extracted data 280, the messages 270, and the invoice files 275 that are stored in association with that account identifier.

The analysis completeness determiner 250 can determine that the first analysis process failed to extract at least one invoice parameter of the predetermined invoice parameters. For example, the desired invoice parameters specified in the configuration of the data processing system 205 may require an invoice identifier, an invoice amount, and an invoice due date. However, the text extraction process may have failed to properly extract the text from the invoice file 275, and therefore at least one of the desired invoice parameters cannot be extracted. The analysis completeness determiner 250 can also determine if the text extraction process response message received from the cloud computing system 260 indicated that the text extraction process failed instead of succeeding. In either of these cases, the analysis completeness determiner 250 can send a signal to the parameter extractor 245 to perform a secondary analysis on the file 275. The secondary analysis can include a different text extraction process, and a different analysis process that is based on regular expressions, as described herein below.

Upon receiving the signal from the analysis completeness determiner 250 to perform the secondary analysis, the parameter extractor 245 can perform an alternative text extraction process on the invoice file 275. Rather than simply marking the file as unrecognizable in the event of an initial text extraction failure, the data processing system 205 can implement a back-up extraction process to improve the accuracy and performance of the invoice analysis process. The backup text extraction process can utilize a different method of text extraction. One such backup process utilizes a text extraction library, such as the PyMuPDF library, to identify and extract all possible text data in the invoice file 275. The backup text extraction process can extract all of the text as a plaintext data structure object. In some implementations, the backup text extraction process can be performed by the cloud computing system 260. In such implementations, the parameter extractor 245 can transmit requests that are similar to those transmitted by the cloud system communicator 240. In response to said requests, the cloud computing system 260 can provide the plaintext data structure object to the parameter extractor 245 via the network 210.

As the plaintext data structure may not have the same hierarchal data structure as that returned by the cloud computing system 260, the parameter extractor 245 can utilize a different analysis process to extract the invoice parameters from the text data. The subsequent analysis process may be a regular-expression extraction process. The regular expression extraction process can apply various rules that can scan or analyze the plain text data structure to identify one or more of the desired invoice parameters (e.g., the invoice parameters that were not extracted using the first analysis process above, or all of the parameters in event that the first text extraction process failed, etc.). In general, a regular expression is a sequence of characters that define a search pattern, which can be used to identify desired patterns in plain text strings. These search patterns can be utilized in conjunction with one or more string-searching algorithms to identify locations in strings that match the string search criteria. In some implementations, the regular expression process can identify one or more keywords in the text data. Using the locations of the keywords in the text data, parameter extractor 245 can iteratively apply regular expressions to identify one or more invoice parameters that are proximate to the identified keywords in the string data structure.

Using a regular expression extraction process can accommodate flaws that may occur during the keyword pair analysis processes. As described herein, the keywords and their associated parameter values are paired based on matching the criteria for the metadata field (e.g., a dollar amount being a number, an address including both numbers and letters, etc.), and the parameter value residing geometrically in-line (horizontally or vertically) from the keyword (within a defined length of the document). Determining which keywords and parameter values are in-line with each other is based on the coordinates output in the JSON analysis. However, as shown in FIG. 9, these coordinates represent a region that surrounds each piece of unbroken text. In instances where optical character recognition (or another text detection technique) fails to capture a break in text, or the document does not have a break in between the keyword and associated parameter value, regular expressions can be used to search for keywords and values that reside within the same bounding region.

The regular expressions can be applied until one or more invoice parameter criteria are met (e.g., extracted an alphanumeric string of a particular length, extracted an alphanumeric string having a prefix such as “Invoice Number, “Invoice No,” etc.). In another example, the regular expression can extract alphanumeric strings starting with ‘#’ as an invoice number, or numeric strings starting with ‘$’ as an amount due, among others. More examples of extracting invoice parameters from text data are described herein in conjunction with FIGS. 6A-6E. When a match to one of the rules in the regular expression is found, the location of the match in the plain text data structure object can be provided to the parameter extractor 245. The parameter extractor 245 can extract the desired information from the plain text data structure and store it in association with the invoice file 275 as the extracted data 280, similar to as described above. This process can be repeated using regular expressions until each desired invoice parameter is extracted.

The analysis completeness determiner 250 can monitor the subsequent analysis process performed by the parameter extractor 245, and determine whether all of the desired invoice parameters are extracted. If all of the invoice parameters are extracted, the analysis completeness determiner 250 can transmit a message to the data structure transmitter 255 to transmit the extracted parameters to a node server. In contrast, if the analysis completeness determiner 250 determines that a value has not been extracted for each of the desired invoice parameters, the analysis completeness determiner 250 can flag the invoice data structure as unrecognizable, or as not completely recognizable. Flagging the file as unrecognized can include storing one or more values in the database 215 with the invoice file 275 that indicates the invoice file 275 cannot be recognized or processed.

Once the extraction and analysis processes are complete, the data structure transmitter 255 can transmit a data structure including the predetermined invoice parameters to a node server. To do so, the data structure transmitter 255 can access the database 215 to retrieve the location identifier of the analyzed invoice file 275 and the extracted data 280 stored in association with the invoice file. The data structure transmitter 255 can then generate the data structure to include the location identifier of the invoice file 275 (e.g., such that it can be accessed by another computing device such as one of the client devices 220, etc.), the extracted data 280, and a status of the analysis. The status of the analysis can indicate which of the desired invoice parameters were extracted, and can include whether any of the analysis processes failed to extract one or more of the desired invoice parameters. The status can also indicate whether the text extraction process performed by the cloud computing system 260 failed. These status values can be retrieved from the analysis completeness determiner 250. After generating the data structure including the file location identifier, extracted data 280, and the relevant status information, the data structure transmitter 255 can transmit the data structure to a node server. The node server can be a message broker server that pushes messages to another server or storage location. In some implementations, the storage location is associated with the account identifier identified in the message that included the invoice file 275.

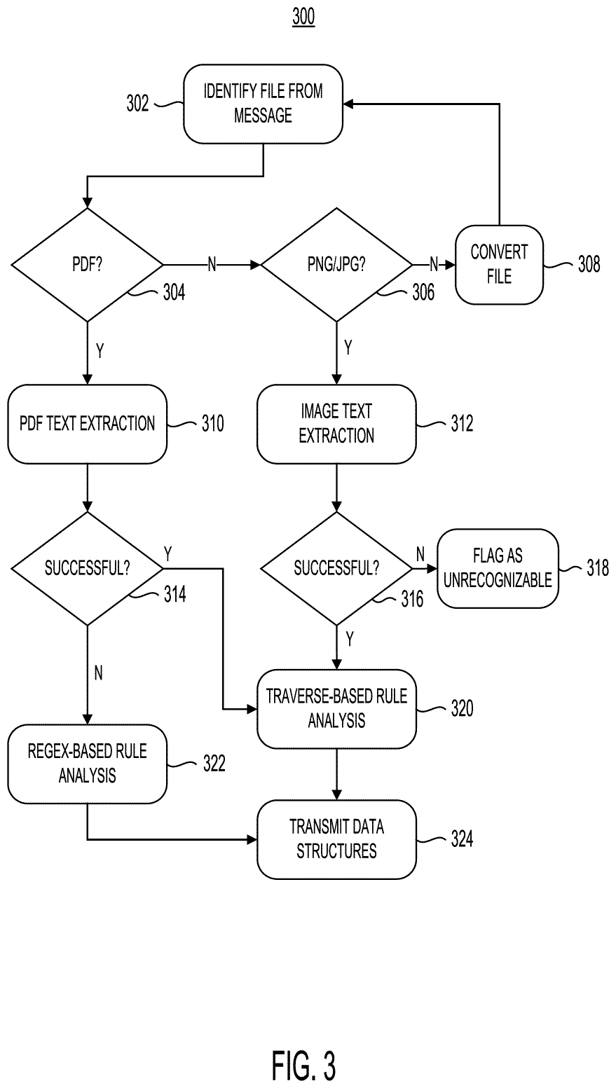

Referring now to FIG. 3, depicted is an illustrative flow diagram of a method 300 for extracting parameters from invoices using a cloud computing system. The method 300 can be executed, performed, or otherwise carried out by the data processing system 205, the computer system 100 described herein in conjunction with FIGS. 1A-1D, or any other computing devices described herein. In brief overview of the method 300, the data processing system (e.g., the data processing system 205, etc.) can identify a file from a message (STEP 302), determine whether the file is a PDF file (STEP 304), determine whether the file is a PNG or JPG file (STEP 306), convert the file (STEP 308), perform PDF text extraction (STEP 310), perform image text extraction (STEP 312), determine whether the PDF text extraction was successful (STEP 314), determine whether the image text extraction was successful (STEP 316), flag the file as unrecognizable (STEP 318), perform traverse-based rule analysis (STEP 320), perform regular expression-based rule analysis (STEP 322), and transmit data structures (STEP 324).

In further detail of the method 300, the data processing system (e.g., the data processing system 205, etc.) can identify an invoice file from a message (STEP 302). In some implementations, identifying a file can include receiving a request for document analysis from a client device (e.g., a client device 220, etc.). As described herein above, a request can be an email message, a text message, a HTTP request message, a file transfer protocol message, or any other type of message that can be transmitted via a network (e.g., the network 210, etc.). The message can include one or more files, which can be invoice documents. For example, if the request is an email message, the one or more files can be identified in the email message as attachments. The attachments can be files that represent invoices, for example a PDF file of an invoice or an image of an invoice. An invoice can include invoice parameters, such as an invoice identifier, a purchase order (PO) number, an invoice amount, or an invoice due date, among others. Each file can be stored in one or more data structures in a database (e.g., the database 215, etc.), and can be identified with a corresponding file location identifier.

The message, or other data accompanying the invoice file, may specify the supplier (e.g., the entity to which payment is owed) of the invoice file. If the supplier name is specified, the supplier name may be utilized as ground truth data in the processes described in connection with FIGS. 7 and 8. If the supplier name is not specified, the data processing system may utilize the machine learning models described in connection with FIGS. 7 and 8 to classify the invoice file as corresponding to a particular supplier. Upon receiving or identifying the invoice file, the data processing system can store the invoice file in a repository (e.g., the database 215). In some implementations, the data processing system can identify the file as a converted file produced in (STEP 308). In such implementations, the data processing system can proceed to (STEP 304) using the converted file instead of the original unconverted file. The file location identifier can be used as an input to a text extraction process, such as the text extraction processes described in (STEP 310) or (STEP 312) below.

The data processing system can determine whether the file is a PDF file (STEP 304). To determine the file type of the identified invoice file, the data processing system can identify a file extension of the file. In some implementations, the data processing system can analyze one or more predetermined regions in the file, such as the file header, to identify one or more predetermined values that indicate file type. If the identified file is determined to be a PDF file, the data processing system can proceed to execute (STEP 310) of the method 300. If the identified file is not determined to be a PDF file, the data processing system can proceed to execute (STEP 306) of the method 300.

The data processing system can determine whether the file is a PNG or JPG file (STEP 306). If the determined file type is not determined to be a PDF file, the data processing system can determine if the file is of another type of supported image format. To determine the file type of the identified invoice file, the data processing system can identify a file extension of the file. In some implementations, the data processing system can analyze one or more predetermined regions in the file, such as the file header, to identify one or more predetermined values that indicate file type. If the identified file is determined to be a PNG or a JPG file, the data processing system can proceed to execute (STEP 312) of the method 300. If the identified file is not determined to be a PNG or a JPG file, the data processing system can proceed to execute (STEP 308) of the method 300.

The data processing system can convert the file (STEP 308). If the file format is a related image format, such as another image file type (e.g., JPEG 2000, EXIF, TIFF, GIF, BMP, RAW, SVG, etc.), the data processing system can convert the file into one of a PDF, a JPG, or a PNG file. The data processing system can perform said conversion using one or more image conversion techniques. The resulting converted file can be stored in association with the respective invoice file in one or more data structures in the database. The converted file can be stored with its own file location identifier, and can be analyzed starting at (STEP 308) of the method 300.

The data processing system can perform PDF text extraction (STEP 310). The PDF text extraction process can be a process performed by a cloud computing system. The PDF extraction process can be an asynchronous text extraction process. To perform the PDF text extraction process, the data processing system can generate and transmit instructions to the cloud computing system (e.g., the cloud computing system 260, etc.) to carry out the text extraction process. The instructions can be in any suitable language, for example, JavaScript or Python instructions. The instructions can indicate the name of the file and the location identifier of the file. The location identifier of the file can be, for example, a 64-bit integer that is unique to the file to be analyzed using the determined text extraction process. The instructions can include an identification of the text extraction process to be performed on the file (e.g., the synchronous or asynchronous version, etc.). For example, in an asynchronous Textract extraction process performed on a PDF file, the data processing system can generate instructions to include the GetDocumentTextDetection function of the Textract API. After transmitting the instructions to the cloud computing system, the data processing system can receive a response message with an identifier of the extraction process for that particular file. The identifier of the extraction process can be used to query the status of the extraction process as it is performed by the cloud computing system. The data processing system can query the cloud computing system until the process has completed, and receives either a success or a failure message.

Once the status indicates a success message, the data processing system can transmit a request to access the results of the extraction process to the cloud computing system. The request to access the results of the extraction process can include the identifier of the extraction process provided by the cloud computing system. In response, the data processing system can receive a response message including one or more objects extracted from the invoice file. The one or more objects can be text objects that stored in a hierarchical format, such as a JSON format. For example, each page in the processed invoice file can be represented as a block object, which can contain one or more line objects containing one or more word objects. The objects can include data structures that include pointers or identifiers to other data structures lower in the hierarchy. A block can contain a list of pointers to line objects, and each line object can include a list of points to word objects, which contain the text information. The word objects can include text information for a single extracted word in an encoded format, for example ASCII or UNICODE. The data structures storing the text information can be structured in a similar arrangement to how the text would be formatted on a rendering of the analyzed document. For example, text at the top left of the document can be stored in the first entries of the data structures, while text at the bottom right of the document can be stored in the final entries of the data structures. The data structures can include, for example, four coordinate pairs defining a region in the document that encompasses each block of text data. The data structures may also include key pair values identified by the extraction process. The key pair values can be metadata identifiers and their associated values (e.g., “Total Amount” can be a key value (a keyword) identifier and “$100” can be the associated value, etc.).

The data processing system can perform image text extraction (STEP 312). The image text extraction process can be a process performed by a cloud computing system. The image text extraction process can be a synchronous text extraction process. To perform the image text extraction process, the data processing system can generate and transmit instructions to the cloud computing system to carry out the text extraction process. The instructions can be in any suitable language, for example JavaScript or Python instructions. The instructions can indicate the name of the file and the location identifier of the file. The location identifier of the file can be, for example, a 64-bit integer that is unique to the file to be analyzed using the determined text extraction process. The instructions can include an identification of the text extraction process to be performed on the file (e.g., the synchronous process, etc.). The image extraction process can be a synchronous Textract extraction process performed on a PNG or a JPG file, and can include instructions using the DetectDocumentText function of the Textract API. After transmitting the instructions to the cloud computing system, the data processing system can receive a response message with an identifier of the extraction process for that particular file. The identifier of the extraction process can be used to query the status of the extraction process as it is performed by the cloud computing system. The data processing system can query the cloud computing system until the process has completed, and receives either a success or a failure message.

The data processing system can determine whether the PDF text extraction was successful (STEP 314). Once the status indicates a success message, the data processing system can transmit a request to access the results of the extraction process to the cloud computing system. The request to access the results of the extraction process can include the identifier of the extraction process provided by the cloud computing system. In response, the data processing system can receive a response message including one or more objects extracted from the invoice file. As described herein above, the one or more objects can be text objects that are stored in a hierarchical manner. In some implementations, the one or more objects can be provided in a hierarchical data format, such as a JSON format. For example, each page in the processed invoice file can be represented as a block object, which can contain one or more line objects containing one or more word objects. The objects can include data structures that include pointers or identifiers to other data structures lower in the hierarchy. A block can contain a list of pointers to line objects, and each line object can include a list of points to word objects, which contain the text information. The word objects can include text information for a single extracted word in an encoded format, for example ASCII or UNICODE. The data structures storing the text information can be structured in a similar arrangement to how the text would be formatted on a rendering of the analyzed document. For example, text at the top left of the document can be stored in the first entries of the data structures, while text at the bottom right of the document can be stored in the final entries of the data structures. If the status indicates a success message, the data processing system can execute (STEP 320) of the method 300. Otherwise, if the status indicates that the text extraction process was not successful, the data processing system can execute (STEP 322) of the method 300.

The data processing system can determine whether the image text extraction was successful (STEP 316). If the status message indicates that the image text extraction process was successful, the data processing system can transmit a request to access the results of the extraction process to the cloud computing system. The request to access the results of the extraction process can include the identifier of the image text extraction process provided by the cloud computing system. In response, the data processing system can receive a response message including one or more objects extracted from the invoice file. As described herein above, the one or more objects can be text objects that are stored in a hierarchical manner. In some implementations, the one or more objects can be provided in a hierarchical data format, such as a JSON format. For example, each page in the processed invoice file can be represented as a block object, which can contain one or more line objects containing one or more word objects. The objects can include data structures that include pointers or identifiers to other data structures lower in the hierarchy. A block can contain a list of pointers to line objects, and each line object can include a list of points to word objects, which contain the text information. The word objects can include text information for a single extracted word in an encoded format, for example ASCII or UNICODE. The data structures storing the text information can be structured in a similar arrangement to how the text would be formatted on a rendering of the analyzed document. For example, text at the top left of the document can be stored in the first entries of the data structures, while text at the bottom right of the document can be stored in the final entries of the data structures. If the status indicates a success message, the data processing system can execute (STEP 320) of the method 300. Otherwise, if the status indicates that the text extraction process was not successful, the data processing system can execute (STEP 318) of the method 300.

The data processing system can flag the file as unrecognizable (STEP 318). Flagging the file as unrecognized can include storing one or more values in the database with the invoice file that indicates the invoice file cannot be recognized or processed. The flagging information can indicate information included in the status message received from the cloud computing system, which can include reasons that the extraction process failed. Once the file has been flagged as unrecognizable, the data processing system can transmit one or more data structures indicating the failure and the identified file to the node server, similar to the operations described below in (STEP 324), however with the extracted invoice parameters absent.

The data processing system can perform traverse-based rule analysis (STEP 320). The traverse-based rule analysis can extract one or more desired invoice parameters from the text data extracted from the invoice file using the text extraction process. The predetermined or desired invoice parameters can be values that are required to correctly process an invoice. For example, the invoice parameters can include an invoice identifier, a PO number, an invoice amount, or an invoice due date, among others. The first analysis process can include a traverse-based rule extraction process. As invoices are designed to be human readable, the desired invoice parameters are typically proximate to an identifier of the particular parameter. For example, an invoice identifier may be preceded by, or close to, the text “Invoice ID:” on a document. To identify a particular parameter, the data processing system can traverse, or iterate through, each of the parameters or sequences of line objects and word objects to identify and extract the requested parameters.

The traversal algorithm can be rule based, where the data processing system compares portions of each line object or word object to one or more conditions, or rules. If a rule is satisfied for a particular invoice parameter, the rule can return or provide an identifier for the location in the one or more line objects or word objects for the invoice parameter. To extract the data, the data processing system can access the one or more line objects or word objects and extract the encoded text data from the location identified by the rule. Extracting the text data can include copying the desired text data into a different region of memory, for example one or more data structures containing the invoice parameters for the invoice file under analysis. However, occasionally the first analysis process using the traversal algorithm may fail to extract all of the desired invoice parameters. The desired invoice parameters can be specified by the client device that provided the messages including the invoice file, or by a client device setting a configuration setting for the data processing system. The extracted invoice parameter values can be stored in one or more data structures in the database or in the memory of the data processing system, and can be stored in association with the invoice file from which the data was extracted. The extracted invoice parameters can include other information about the invoice, such as the source of the invoice, the account identifier associated with the invoice (e.g. the account that transmitted the invoice to the data processing system, etc.), among others.

The data processing system can perform regular expression-based rule analysis (STEP 322). If the standard PDF text extraction fails, the data processing system can perform an alternative text extraction process on the invoice file. Rather than simply marking the file as unrecognizable in the event of an initial text extraction failure, the data processing system can implement a backup extraction process to improve the accuracy and performance of the invoice analysis process. The backup text extraction process can utilize a different method of text extraction. One such backup process utilizes a text extraction library, such as the PyMuPDF library, to identify and extract all possible text data in the invoice file. The backup text extraction process can extract all of the text as a plaintext data structure object. In some implementations, the backup text extraction process can be performed by the cloud computing system. In such implementations, the data processing system can transmit requests that are similar to those transmitted by the data processing system in (STEP 310), but instead identifying the alternative text extraction process instead of the Textract process. In response to said requests, the cloud computing system can provide a plaintext data structure object to the data processing system in one or more messages via the network.

As the plaintext data structure may not have the same hierarchal data structure as that returned by the cloud computing system when the Textract process is used, the data processing system can utilize a second, different analysis process to extract the invoice parameters from the text data. The subsequent analysis process may be a regular-expression extraction process. The regular expression extraction process can utilize various rules to scan, search, or analyze the plain text data structure to identify one or more of the desired invoice parameters (e.g., the invoice parameters that were not extracted using the first analysis process above, or all of the parameters of the first text extraction process failed, etc.). In general, a regular expression is a sequence of characters that define a search pattern, which can be used to identify desired patterns in plain text strings. These search patterns can be utilized in conjunction with one or more string-searching algorithms to identify locations in strings that match the string search criteria. When a match to one of the rules in the regular expression is found, the location of the match in the plain text data structure object can be provided to the data processing system. The data processing system can extract the desired information from the plain text data structure and store it in association with the invoice file as the extracted invoice parameters including other invoice data, similar to as described above in (STEP 314). This process can be repeated using regular expressions until each desired invoice parameter is extracted from the plaintext data.

The data processing system can transmit data structures (STEP 324). Once the extraction and analysis processes are complete, the data processing system can transmit a data structure including the predetermined invoice parameters to a node server. To do so, the data processing system can access the database to retrieve the location identifier of the analyzed invoice file and the extracted invoice data stored in association with the invoice file. The data processing system can then generate the data structure to include the location identifier of the invoice file 275 (e.g., such that it can be accessed by another computing device such as one of the client devices, etc.), the extracted invoice data, and a status of the analysis. The status of the analysis can indicate which of the desired invoice parameters were extracted, and can include whether the traverse based analysis process or the regular expression based analysis process failed to extract one or more of the desired invoice parameters. The status can also indicate whether the text extraction process performed by the cloud computing system failed. After generating the data structure including the file location identifier, extracted invoice data, and the relevant status information, the data processing system can transmit the data structure to a node server. The node server can be a message broker server that pushes messages to another server or storage location. In some implementations, the storage location is associated with the account identifier identified in the message that included the invoice file.

FIGS. 4A, 4B, 4C, 4D, 4E, 4F, 4G, 4H, 4I, 4J, 4K, and 4L each depict different views of an example user interface that communicates with the systems. The user interface can be presented, for example, on a display of a client device, such as the client devices 102 described herein in conjunction with FIGS. 1A-1D, or the client device 220 described herein above in conjunction with FIG. 2. In some implementations, the user interface can be presented as a webpage in a web browser or another type of application that can present webpages or websites. In some implementations, the user interface can be provided as a native application that can execute locally on the client device presenting the user interface. The following descriptions of FIGS. 4A-4L pertain to various aspects of the user interface, and should not be construed as limiting on the capabilities of the client devices described herein or on the systems with which the client devices communicate.

Referring now to FIG. 4A, depicted is a login screen presented to the user upon first accessing the web-based application. As described herein above, the web-based application can cause a user interface to be displayed on the client device, and the client device can interact with actionable objects to carry out desired actions. To log into the web application, the client device can provide login information, which is depicted here as an email as a password. However, it should be understood that other login information is possible, such as a username or a passkey, among others. After entering the login information for an account with the cloud computing environment, the client device can access said account, including any invoices or other settings as described herein below, by interacting with the login button.

Referring now to FIG. 4B, depicted is a dashboard interface that displays information associated with the account identified by the login credentials entered in the interface displayed in FIG. 4A. The dashboard can provide statistics about the invoices processed by the system for that account, which can include a number of pending invoices and a number of approved invoices. Other statistics are possible, such as the bar graph depicting invoices over periods of time or the pie graph that indicates the percentage of invoices that fall within predetermined invoice amounts. The left-hand pane shows a logo and four actionable text objects. The HOME text object can return the client device to the home dashboard interface. The INVOICE text object can cause the web browser or application executing on the client device to navigate to an invoice dashboard interface. The MY TEAM text object can cause the client device to navigate to an interface that allows for the modification of account permissions for other users. The MANAGE PROFILE text object can cause the client device to navigate to an interface where the user can change or modify aspects of their account or profile.

Referring now to FIG. 4C, depicted is the user interface for an invoice dashboard. As above, the left-hand pane shows a logo and four actionable text objects that can cause the client device to navigate between pages. The invoice dashboard can display a list of invoices that have been processed by the system (e.g., the system 200, etc.) as described herein above. In this example, the invoices messages are emails transmitted by email addresses, which are each displayed with an identifier of a respective invoice transmitted by that email address. Other information is shown for each invoice, such as a status (e.g., pending or waiting to be approved, auto approved, validation failure, approved, or validation failure, etc.), an invoice amount, and a company identifier from which the invoice was transmitted. In addition, each invoice includes a Manage actionable object that causes the client device to navigate to an action pane for that particular invoice, for the purposes of performing one or more actions on the invoice. For example, the actions can include exception processing tasks, where the issues can be resolved that are preventing invoice data being recognized with Textract (e.g., validation failure, etc.), or working with invoices that do not contain desired invoice parameters (e.g., no PO number or invalid PO number, etc.). An invalid PO number can be identified by comparing the PO number on the invoice to purchase orders stored in a database.

As above, the actions can include resolving validation failures. One type of validation error is a data extraction error, such as when an invoice is flagged as unrecognizable by the system. Such actions can allow for the processing of exceptions with the Textract process by accessing a queue to see invoices that were rejected by the Textract process or other text extraction process, and manually resolve the issue by entering in desired information. Other types of validation failures are non-PO processing or account distribution issues. For example, if an invoice lacks a desired invoice parameter (e.g., does not include a PO number, or the PO number is invalid as determined by not matching a PO number in a database, etc.) the client device can be prompted to enter the coding information required to process the invoice (e.g., the missing information, etc.). Once this data is entered, the database of purchase orders can be updated, as well as the JSON file or other data structures including the invoice parameters for storage in the database. Other validation errors can include invoices that have failed to be inserted into an ERP. Generally, such situations can be related to syntax within the invoice metadata (e.g., the extracted invoice parameters, etc.) being a mismatch to data stored in the ERP. The client device can be prompted to resolve these issues (e.g., to correct the syntax, etc.) and insert the invoice back to the ERP. Another validation error can occur when duplicate invoices fail to be inserted into the ERP system. In such situations, the client device can be prompted to resolve the occurrence of duplicate invoices in the queue to the ERP (e.g., by prompting the client device to remove the duplicate invoice, etc.).

Referring now to FIG. 4D, depicted is a management interface for an invoice that is pending or waiting to be approved. As above, the left-hand pane shows a logo and four actionable text objects that can cause the client device to navigate between pages. More items of the extracted invoice parameters can be displayed in this page, including the invoice number, the invoice date, the invoice due date, and the invoice amount. An actionable object that causes the invoice file (here depicted as a PDF file) to be displayed or downloaded to the client device can be included in this interface, along with the data structures (in this example, a JSON file) that contain the invoice metadata. The actionable objects at the bottom of the interface allow the user to manually edit the extracted invoice parameters, or to approve the invoice.

Each account that accesses the interface can have a different set of permissions that can allow certain invoices to be approved. Generally, account profiles can only approve invoices having amounts that are up to an assigned threshold. This amount can be customizable by an administrator account (e.g., using the manage team interface, etc.), and can vary between accounts and administrator accounts. For example, a workflow can be created that allows all invoices under $5,000 total amount to skip the approval process (e.g., be auto approved). Invoices $5,001 to $50,000 can be assigned to a queue for a first user account, and $50,000+ can be assigned to a second user account having elevated privileges. Such queues can have actions such as approve or route the workflow item to a different user account. User accounts can have invoice approval limits as part of a user account attribute. Referring briefly now to FIG. 4E, depicted is a view of the user interface displaying a rendering of the invoice file in response to an interaction with the actionable object for the invoice file in FIG. 4D. The invoice file can be closed and return to the interface in FIG. 4D in response to an interaction with the close button.

Referring now to FIG. 4F, the invoice dashboard user interface can also allow a client device to upload an invoice file for processing instead of sending a message (e.g., an email, etc.) to the user interface. For example, the invoice file can be dragged (e.g., a drag and drop interaction) into the designated area in the user interface to cause the client device to upload the invoice file to the system for processing. Alternatively, the client device can select a radio button to enter the invoice data manually (e.g., skipping the invoice uploading process, etc.). For example, referring now to FIG. 4G, the client device can display an interface that includes fields for desired invoice parameters, such as an invoice number, an invoice date, an invoice due date, an invoice total amount, and a purchase order number. The client device can also select another radio button to cause the user interface to display fields relating to an invoice without a PO number. For example, referring now to FIG. 4H, the user interface can display other desired invoice parameters for invoices that do not include a purchase order, such as an invoice number, an invoice date, an invoice due date, an invoice total amount, a name of the party providing the invoice, an email address of the party providing the invoice, a phone number of the party providing the invoice, and a company name of the party providing the invoice. By interacting with the submit button, the client device can confirm that the invoice data is correct and the invoice can be provided to one or more queues for further processing.

Referring now to FIG. 4I, depicted is a team management interface for the invoice processing system, where user accounts for a particular invoice account can be created, modified, or deleted. For example, the list can include a search field to search for user accounts. The user account can be associated with a serial number, which can serve as a user account identifier. The user account can be associated with a name (here, the name is displayed as “Carter”). The user account can be associated with approval ranges. Here, the user account has permissions to approve invoices having amounts within the range of $1000 to $3000. The user account can be associated with a password, which can be changed by interacting with the “Change Password” button. To edit attributes of a particular user account, the client device can interact with the pencil icon next to the user account to be edited. In addition, attributes of the invoice account can be modified, such as the auto approval amount range, by interacting with the “Edit Auto Approval Amount” button. A user account can be added to the invoice account by interacting with the “Add Member’ button.

Referring now to FIG. 4J, depicted is the user interface displayed when the client device attempts to add a user account to the invoice account. Various parameters can be set by the client device, including the name for the user account, the password for the user account, and the range of invoice amounts that the invoice account is permitted to approve. Once these values have been set, the user can add the user account to the invoice account by interacting with the “ADD” button. When adding the user account to the invoice account, the user account can be assigned (e.g., automatically, etc.) a serial number that identifies the user account.

Referring briefly now to FIG. 4K, depicted is a user interface that can be used to modify parameters of the invoice account (e.g., the account that can manage the invoice system for a particular organization, etc.). As above, the left-hand pane shows a logo and four actionable text objects that can cause the client device to navigate between pages. As shown in the user interface, the client device can change the password of the invoice account by entering in the current password (shown here as “old password”), along with a new password. To confirm the password change, the new password can be entered a second time. By interacting with the “UPDATE” button, the client device can send a message that causes the system to change the password of the invoice account to the new password. Referring briefly now to FIG. 4L, depicted is a user interface that allows the client device to modify the amount up to which the system can auto approve invoices. For example, by entering in $3000, the system can be configured to approve invoices automatically having amounts due that are less than or equal to $3000.

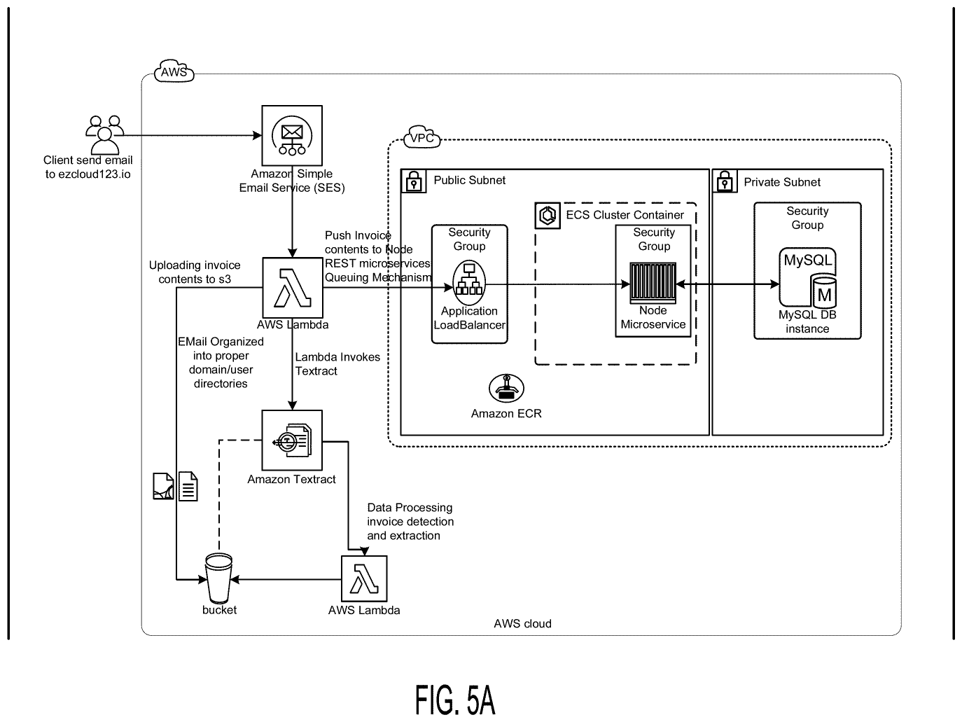

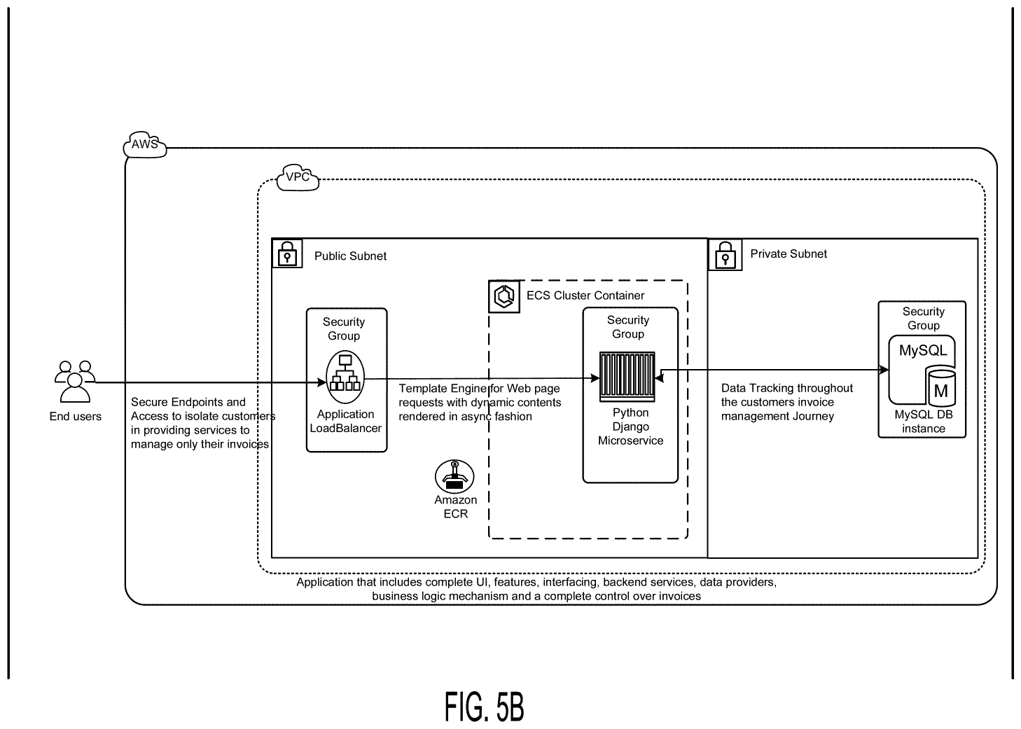

Referring now to FIG. 5A, depicted is a high-level block diagram of the invoice extraction process in an example cloud computing environment. The functionality of the cloud computing environment can be similar to the cloud 108 described herein above in conjunction with FIG. 1B, and can be implemented in part by the computing devices depicted in FIG. 2, such as the data processing system 205, the cloud computing system 260, or the client devices 220. As shown in the diagram, a client can transmit one or more messages (in the figure, depicted as an email), to a cloud computing system that implements a simple email service. An email service can receive the email, and forward the contents to a computing device for invoice analysis as described herein above. The computing device can store the invoice file into a bucket, or database storage location, and receive a file location identifier that identifies the location of the file in the bucket.

Using the file location identifier, the computing device can send an indication to the Textract service executing on another node of the cloud computing environment. As the database and the Textract node are part of the same cloud, the computing device coordinating the invoice analysis operations need not necessarily forward the invoice file directly to the Textract node. Once the Textract node has extracted the text data from the invoice file, the results of the extraction can be stored in the same bucket in association with the invoice file, and can be assigned its own location identifier. Next, the location identifier for the text information can be forwarded to a different computing node that performs analysis on the text data, as described herein above. As described herein above, the analysis can produce one or more data structures that include desired invoice parameters, such as an invoice amount, an invoice due date, a PO number, or any other invoice parameter described herein. The results of the analysis (or backup analysis, as the case may be) can be stored in association with the invoice file and the Textract data, along with any status values generated during the extraction or analysis processes.

Finally, the computing device coordinating the invoice extraction and analysis processes can transmit the invoice file, the extracted text information, the status values, and the extracted invoice parameters to a node service that provides an interface to a private subnet. Clients can view the analyzed invoices, along with other relevant account information, by communicating directly with the node service. Although the services shown in FIG. 5A are depicted as those that form a part of the AMAZON WEB SERVICES API (e.g., Lambda services in Python code, Textract services, s3 buckets, Simple Email Service, etc.), it should be understood that similar operations can be performed with other cloud computing services. Likewise, the node server need not be a messaging service communicating with a database on a private subnet, and can instead be any server capable of receiving messages or other data from the computing devices described herein.

Referring now to FIG. 5B, depicted is a high-level block diagram of a user application accessing data produced and maintained by the example cloud computing environment in FIG. 5A. Invoice files that have been processed and stored in the database on the private subnet can be accessed by client devices that communicate with the messaging service on the cloud computing environment. For example, the cloud computing environment can provide one or more web applications that cause the client devices to display a user interface (e.g., the user interface described herein above in conjunction with FIGS. 4A-4L, etc.). The client device can access the invoices and the associated data extracted from said invoices by interacting with the user interface to perform various actions. The actions can include processing invoices, modifying account information, modifying team information, changing team data, other actions described herein, among others.

Referring now to FIGS. 6A-6E, depicted are portions of example invoices that include example invoice parameters. The regular expressions described herein can be used to extract one or more invoice parameters from the example invoices. Referring now to FIG. 6A, depicted is a portion of an example invoice that includes invoice parameters, such as an invoice number, an order number, an invoice date, a due date, and a total amount due, among others. An example regular expression that can be used to extract the invoice number can be “(?i)\hat{ }(invoice number)( )*\d$”. Referring now to FIG. 6B, depicted is a portion of an example product order form that includes an invoice number. An example regular expression that can be used to extract the invoice number in the product order form can be “\hat{ }#\s{0,5}[\w+|_|+|−]*$”. Referring now to FIG. 6C, depicted is a portion of another example invoice. The example invoice includes an invoice date, a purchase order number, and a due date, among other invoice parameters. An example regular expression that can be used to extract the invoice number from the invoice in FIG. 6C can be “(?i)\hat{ }(invoice #)( )*\d$”. Referring now to FIG. 6D, depicted is a portion of an example invoice including a tax rate, a tax amount, and an invoice total, among other invoice parameters. An example regular expression that can be used to extract the invoice total can be “(?i)\hat{ }(invoice total) ( )*\$( )*\d*.\d{1,3}$”. Referring now to FIG. 6E, depicted is a portion of another example invoice. The example invoice includes an invoice number, an invoice date, a purchase order number, and a due date, among other invoice parameters. An example regular expression that can be used to extract the invoice number can be “\hat{ }US-\s{0,5}[\w+|_|+|−]*$”. Although particular regular expressions are described herein in conjunction with FIGS. 6A-6E, it should be understood that any type of regular expression can be used to extract any of the invoice parameters described herein.

Referring now to FIG. 7, depicted is an example flow diagram of a process 700 for generating a machine learning model that classifies documents (e.g., invoices) by supplier, in accordance with one or more implementations. The operations of the process 700 may be performed, for example, by the data processing system 205 or the cloud computing system 260 (or combinations thereof) described in connection with FIG. 2. The flow diagram of the process 700 begins by receiving one or more templates from a user (e.g., uploaded by a client device 220 accessing a web-based interface of the data processing system 205 described in connection with FIG. 2, etc.). The user-uploaded templates 705 (and new templates 710) can be any type of invoice or file (e.g., a file 275). In some implementations, when training the machine learning model, the user-uploaded templates 705 may be uploaded with additional metadata that includes ground-truth data that indicates the supplier of the user-uploaded template 705. The user-uploaded template 705 may be provided to the data processing system 205 using any of the transmission processes described herein, including via email. In some implementations, the ground-truth data for the template 705 may be determined based on an email address associated with the template. For example, a lookup table (which may be pre-populated with information) that maps email domains to suppliers may be accessed by the data processing system to determine the supplier name associated with the template 705. This ground-truth data is then used in later process steps to train the machine-learning model. Similarly, the new template(s) 710 may be invoices or other files 275 that include an indication that the new template 710 is associated with a supplier that the machine learning classifier 720 has not been trained for, such as a new supplier.

Once the user (or the data processing system 205) provides a template 705 (either for testing purposes or for supplier classification), the system performing the process 700 can execute machine learning classifier 720 using the template 705 as input. The machine learning classifier 720 can be any type of machine learning model, including a neural network (e.g., a convolutional neural network, a fully connected neural network, a recurrent neural network, etc.), a linear regression model, a sparse vector machine model, a decision tree model, a random forest model, or another type of artificial intelligence model. In some implementations, the machine learning classifier 720 can be an unsupervised algorithm that clusters the templates 705 based on similar characteristics. Each of the clusters generated by the unsupervised algorithm can correspond to a particular supplier.

The machine learning classifier 720 can be a neural network with one or more layers. The first layer in the machine learning classifier 720 can be an input layer, and can receive data as input such as a vector, a tensor, or another data structure with one or more fields. To input the template 705 to the machine learning classifier 720, various values can be extracted from template 705. For example, if the template 705 is provided as input without any prior feature extraction process (e.g., the feature extraction process 715), the pixels of the template 705 (e.g., when rendered as a PDF, or the pixels of an image of the template 705) can be formatted into a data structure that corresponds to the dimensions of the input layer of the machine learning classifier 720. Similarly, if a feature extraction process such as the feature extraction process 715 is performed, the features output by the feature extraction process 715 can be formatted into a data structure that corresponds to the dimensions of the input layer of the machine learning classifier 720, and can be provided as input to the machine learning classifier 720.

The machine learning classifier 720 can include one or more hidden layers of neurons (sometimes referred to as a “perceptron”), which can include one or more trainable weight or bias parameters. Each neuron in the hidden layer can receive one or more outputs from the preceding layer, and generate an output value by first multiplying each input value by a corresponding trained weight parameter, and then summing the resulting products. In some implementations, a trained bias value may be added or subtracted from the sum to generate the output value. Outputs for each neuron in a hidden layer can be calculated using similar processes, and then provided as input to the next hidden layer in the machine learning classifier 720. This process is repeated until the input data has propagated through each layer in the machine learning classifier 720, finally generating the output classification 725. In some implementations, an activation function (e.g., a linear activation, a ReLU activation function, a logistic activation function, etc.) can be applied to the outputs of each hidden layer prior to providing the output of the hidden layer to the next layer in the machine learning classifier 720.

The output classification 725 generated by the machine learning classifier 720 can be a numerical value that identifies a particular supplier that is predicted by the machine learning classifier 720 to correspond to the input template 705. In some implementations, the output classification 725 can be generated by performing a “softmax” function over a vector of output values generated by the output layer of the machine learning classifier 720. For example, the outputs generated by the machine learning classifier 720 may be a vector data structure including probability values that each correspond to the likelihood that the input template 705 is associated with a respective supplier. A soft-max operation normalizes the output values such that the sum of the output values is equal to one. The supplier that corresponds to the input template 705 is the supplier that is associated with the greatest probability value in the vector. In some implementations, the machine learning classifier 720 can be trained to output a numerical identifier of the predicted supplier.

The output classification 725 generated by the machine learning classifier 720 can then be provided as input to the dynamic extraction process 740. The dynamic extraction process 740 can be an extraction process that extracts invoice parameters from the structured data returned from a text extraction process. The dynamic extraction process 740 can include the operations performed by the data processing system 205 described in connection with FIG. 2, as well as the operations of the method 300 described in connection with FIG. 3. The dynamic extraction process 740 can utilize the predicted supplier of the input document to select one or more extraction rules (e.g., regular expressions, predetermined values or fields, etc.) for the invoice document (e.g., the template 705), thereby improving the efficiency and accuracy of the parameter extraction process. The static extraction process 745 can include similar operations, but without the advantage of supplier-specific rulesets. Instead, the static extraction process 745 can include operations performed by the parameter extractor 245 without the use of the supplier-specific values, fields, or rules. The output of the dynamic extraction process 740 is the output data 750, which can include the extracted data 280 described in connection with FIG. 2.

If the classification of the supplier for the input template 705 is known (e.g., the template 705 is provided as test data for a supplier), the output classification 725 and the ground-truth data provided with the template 705 can be used to train the machine learning classifier. The template 705 and the ground-truth information can then be incorporated into the training data 735. The training data 735 can be a set of templates 705 for which the ground-truth supplier information is known. In some implementations, the system executing the process 700 can augment the training data 735 by replicating templates 705 and modifying one or more values in the replicated template 705 (e.g., the invoice amount, number of invoice items, etc.) to increase the number of unique templates in the training data 735. As shown, during the training process, the training data 735 can be subjected to the feature extraction process 715 to extract one or more features, which are then provided as input to the machine learning classifier 720 in a supervised or unsupervised training algorithm. In such implementations, the input to machine learning classifier 720 may be the extracted features, rather than the template 705 itself.

The feature extraction process 715 may modify or otherwise define a set of features, or image characteristics, which will most efficiently or meaningfully represent the information of interest in the template 705. For example, the images of the training data 735 (or the template 705) can be converted to grayscale to make the image consistent. Various filters may be applied to increase sharpness or other qualities of the templates 705. This can enhance the features of the invoice that may include information related to the supplier, allowing for increased accuracy during model training and model inference. Additionally, filtering the templates 705 or the training data 735 can increase consistency across different files, and therefore enhance prediction accuracy across large datasets that may include different images of different quality. In addition, the feature extraction process 715 can include performing data augmentation techniques for training data, such as replicating and rotating, transforming, or distorting the templates 705 by random amounts, thereby creating additional training data 735 without requiring additional invoice files. This can improve overall accuracy of the machine learning classifier 720 during and after training. Generally, a larger and more diverse training data set results in a more accurate machine learning classifier 720. In some implementations, the feature extraction process can extract one or more features from the templates 705, and provide the features as input to the machine learning classifier 720. Some non-limiting examples of the features can include a color of the template 705 image, one or more fonts being used, and invoice structure, among others.

To train the machine learning classifier 720, the computing system performing the process 700 can perform the update model 730 process, which may utilize any of the training data 735 or any user-provided templates 705 (which include ground-truth data). The update model 730 process can implement any type of supervised, unsupervised, or semi-supervised training algorithm to update the trainable parameters of the machine learning classifier 720. For example, the update model 730 may perform a supervised training process involving back-propagation techniques. Back-propagation techniques can involve propagating one or more items of training data 735 (or templates 705) through the model to generate one or more output classifications 725. The generated output classifications 725 are then compared to the respective ground-truth label in the training data 735 to generate an error value. These error values can then be applied to a loss function, the output of which is used to adjust the trainable parameters (e.g., the weights, the biases, etc.) of the machine learning classifier 720. The trainable parameters of the machine learning classifier 720 can be updated according to a configurable learning rate value. This process can be repeated using various subsets of the training data 735 (some of which may be used as test data to determine an average accuracy of the machine learning classifier 720) until a predetermined model accuracy is achieved. Once trained, the machine learning classifier 720 can be used to classify the supplier of files 275 as described herein.

Referring now to FIG. 8, depicted is an example flow diagram of a process 800 for classifying and extracting information from documents using machine learning models, in accordance with one or more implementations. The operations of the process 800 may be performed, for example, by the data processing system 205 or the cloud computing system 260 (or combinations thereof) described in connection with FIG. 2. Any of the processes or operations described in connection with the process 800 may be performed by any of the components of the data processing system 205, and can be, for example, performed as part of the operations of the method 300 described in connection with FIG. 3.

The flow diagram of the process 800 begins by receiving one or more invoices (e.g., the files 275) from a user (e.g., uploaded by a client device 220 accessing a web-based interface of the data processing system 205 described in connection with FIG. 2, etc.), or from a supplier. The user may provide invoice files by using a scanner upload feature (e.g., using a scanner device as a client device 220), using a file upload interface at a client device 220 via a web-based portal, via a camera at a client device 220, via an email, or via batch upload (e.g., batch upload via a scanner, or from multiple files). A supplier may provide invoices via an upload interface (e.g., via a web-based portal), or via an email.

When an invoice file is received, the data processing system can determine if a supplier is associated (e.g., mapped) to the invoice file. For example, when receiving invoice files from a user via a client device (e.g., a scanner upload, web-based upload, email, or camera upload), the data processing system can determine whether the user has specified a corresponding supplier for the invoice file. If the user has specified a supplier that is associated with the invoice file, the data processing system can perform the dynamic extraction process 840 using the invoice file as input. Otherwise, the data processing system can perform the feature extraction process 815 using the invoice file as input. As shown, in situations where the user performs a batch upload of invoice files, the supplier mapping for the invoice files may not occur, and the batch of invoice files may be provided as input to the feature extraction process 815.

Suppliers may also provide invoice files via email or via a web-based portal or application portal, as described herein. When the supplier uploads an invoice file via the web-based portal to the data processing system, the supplier can provide an identifier (e.g., a supplier name) with the invoice file. The provided supplier name can then be used to access supplier-specific rules or models in the dynamic extraction process 840, which extracts information of interest from the invoice file. However, if the supplier provides the invoice file via email, the name of the supplier may not be included in the email message. To identify the name of the supplier, the data processing system can provide the email address of the supplier (e.g., which may be extracted from a “from” field in the email message) as input to the supplier identifier model 810.

The supplier identifier model 810 can be any type of machine learning model, including a neural network (e.g., a convolutional neural network, a fully connected neural network, a recurrent neural network, etc.), a linear regression model, a sparse vector machine model, a decision tree model, a random forest model, or another type of artificial intelligence model. In some implementations, the supplier identifier model 810 can be an unsupervised algorithm that maps associations between supplier emails and supplier names based on similar characteristics. Each of the clusters of email addresses (or email domains) generated by the unsupervised algorithm can correspond to a particular supplier. In some implementations, the supplier identifier model 810 can receive the entire email address of the supplier of the invoice file as input. However, in some implementations, the supplier identifier 810 may receive the email domain of the supplier of the invoice file as input. The supplier identifier model 810 may be trained using one or more artificial intelligence training techniques, such as supervised learning techniques (e.g., using batches of email addresses with known email associations), or unsupervised learning techniques.

The supplier identifier model 810 may be a neural network with one or more layers. The first layer in the supplier identifier model 810 can be an input layer, and can receive data as input such as a vector, a tensor, or another data structure with one or more fields. To input the supplier email address into the supplier identifier model 810, the email address can be formatted into a data structure that corresponds to the dimensions of the input layer of the supplier identifier model 810. In some implementations, one or more characters of the email address may be provided as input to the model in a particular order, for example, if the supplier identifier model 810 is a recurrent neural network model, such as a long short-term memory (LSTM) model.

The supplier identifier model 810 can include one or more hidden layers of neurons (such as a “perceptron”), which can include one or more trainable weight or bias parameters. Each neuron in the hidden layer can receive one or more outputs from the preceding layer, and generate an output value by first multiplying each input value by a corresponding trained weight parameter, and then summing the resulting products. In some implementations, a trained bias value may be added or subtracted from the sum to generate the output value. Outputs for each neuron in a hidden layer can be calculated using similar processes, and then provided as input to the next hidden layer in the supplier identifier model 810. This process is repeated until the input data has propagated through each layer in the supplier identifier model 810, finally generating a predicted supplier name (e.g., or an identifier of a corresponding known supplier). In some implementations, an activation function (e.g., a linear activation, a ReLU activation function, a logistic activation function, etc.) can be applied to the outputs of each hidden layer prior to providing the output of the hidden layer to the next layer in the supplier identifier model 810.

In some implementations, the supplier identifier model 810 can be a rule-based similarity model that compares the input supplier email address to a list of known supplier names. The supplier identifier model 810 can perform a comparison operation between each of the known supplier names and the email address to calculate a similarity score. Each of the supplier names can then be ranked by their corresponding similarity score, and the highest score can be chosen as the predicted supplier name for the input email address. In some implementations, a portion of the email address (such as the email domain) can be compared to the list of known supplier names, rather than the entire email address. If the largest of the similarity scores calculated for the known suppliers does not satisfy a threshold, the supplier identifier model 810 can indicate that the supplier name could not be predicted with sufficient confidence. If the supplier can be predicted with sufficient confidence by the supplier identifier model 810, the data processing system can perform the data extraction process 840 using the invoice file and the predicted supplier name as input. Otherwise, the data processing system can provide the invoice file as input to the feature extraction process 815.

The feature extraction process 815 can be similar to, and include all of the functionality of, the feature extraction process 715 described in connection with FIG. 7. The feature extraction process 815 can receive the invoice file as input, and generate a set of features, which can be provided to the machine learning classifier 820 as input. The machine learning classifier 820 can be similar to, and include all of the functionality of, the machine learning classifier 720 described in connection with FIG. 7. The features extracted by the feature extraction process 815 can be provided as input to the machine learning classifier 820, which can be trained to output a supplier name or supplier identifier based on the input data, as described herein. The identifier of the supplier name, along with the invoice file, can then be provided as input to the dynamic extraction process 840. The dynamic extraction process 840 can be similar to, and include all of the functionality of, the dynamic extraction process 740 described in connection with FIG. 7. The dynamic extraction process 840 can receive the invoice file and the identifier of the supplier as input, and generate output data 850, using the techniques described herein. The dynamic extraction process 840 can include any of the operations described in connection with FIGS. 2 and 3. The output data 850 can be similar to the output data 750, and can include the extracted data 280 described in connection with FIG. 2.

The dynamic extraction process 840 can include providing text information extracted from the invoice file into a keyword extraction model. The keyword extraction model can be any type of machine learning model, including a neural network (e.g., a convolutional neural network, a fully connected neural network, a recurrent neural network, etc.), a linear regression model, a sparse vector machine model, a decision tree model, a random forest model, or another type of artificial intelligence model. In some implementations, the keyword extraction model can be an unsupervised algorithm that maps associations between desired metadata and corresponding keywords present in invoice files. The keyword extraction model may be trained such that a corresponding set of keyword-metadata mappings are generated for each known supplier in the list of suppliers. If the supplier is unknown or not provided, the keyword extraction model may utilize a default set of keyword-metadata mappings. The keyword extraction model may therefore provide a customized extraction process (e.g., to extract the invoice parameters from the invoice) on a per-supplier basis.

The keyword extraction model may be trained using one or more artificial intelligence training techniques, such as supervised learning techniques (e.g., using sets of keywords with known metadata associations), or unsupervised learning techniques. The keyword extraction model may be a neural network with one or more layers. The first layer in the keyword extraction model can be an input layer, and can receive data as input such as a vector, a tensor, or another data structure with one or more fields. To input the text of the invoice into the keyword extraction model, the text (or blocks of text) can be formatted into one or more data structures that correspond to the dimensions of the input layer of the keyword extraction model. In some implementations, one or more characters of the invoice text data may be provided as input to the model in a particular order, for example, if the keyword extraction model is a recurrent neural network model, such as an LSTM model.

The keyword extraction model can include one or more hidden layers of neurons (such as a “perceptron”), which can include one or more trainable weight or bias parameters. Each neuron in the hidden layer can receive one or more outputs from the preceding layer, and generate an output value by first multiplying each input value by a corresponding trained weight parameter, and then summing the resulting products. In some implementations, a trained bias value may be added or subtracted from the sum to generate the output value. Outputs for each neuron in a hidden layer can be calculated using similar processes, and then provided as input to the next hidden layer in the keyword extraction model. This process is repeated until the input data has propagated through each layer in the keyword extraction model, finally generating a mapping between a keyword and corresponding metadata (e.g., or an identifier of corresponding metadata) in the input file. Some example mappings of keywords to metadata for an invoice file are shown in FIG. 9. In some implementations, an activation function (e.g., a linear activation, a ReLU activation function, a logistic activation function, etc.) can be applied to the outputs of each hidden layer prior to providing the output of the hidden layer to the next layer in the keyword extraction model.

In some implementations, the keyword extraction model can be a rule-based similarity model that compares the input text data of the invoice file to a list of known key-pairs values. The keyword extraction model can perform a comparison operation between each of the known key-pairs values and portions of the text data to calculate a similarity score. Each of the key-pairs can then be ranked by their corresponding similarity score, and the highest score can be chosen as the predicted keyword-metadata mapping for the input text data portion of the invoice. In some implementations, if the largest of the similarity scores calculated for the known suppliers does not satisfy a threshold, the keyword extraction model can output an “unknown” mapping value, indicating that an input keyword or text block has an unknown mapping to desired metadata. The mappings between keywords extracted from the invoice file and corresponding metadata extracted from the invoice file can be used in horizontal and vertical analysis techniques for other invoice files to produce the output data 850.

The user of the data processing system can also provide one or more user modifications 830 to the list of known supplier names or to the metadata keywords associated with each supplier name. The user may provide the user modifications 830 via a web-based interface provided by the data processing system. Upon receiving a modification to the list of known suppliers (e.g., an addition to the list or a change to an existing name in the list), the data processing system can update a database (e.g., the database 215, or another memory device of the data processing system, etc.) to reflect the modification. In addition, once a modification to a supplier name has been made, the data processing system can perform training operations similar to those of the update model process 730 described in connection with FIG. 7, to train the machine learning classifier 820 and the supplier identifier model 810. For example, the data processing system can perform one or more supervised learning techniques to update the machine learning classifier 820 and the supplier identifier model 810, to accommodate the modified list of known suppliers. If either of the machine learning classifier 820 or the supplier identifier model 810 utilizes an unsupervised learning technique, the data processing system can update the list of known suppliers used by the model to generate one or more classification clusters.

If a supervised learning technique is used, the data processing system can perform supervised learning processes similar to those described in connection with the update model process 730 described in connection with FIG. 7. Training data for the machine learning classifier 820 can be any previous invoice file provided to the data processing system, and the ground-truth data for the invoice file can be the known (or predicted) supplier name for that invoice file. Training data for the supplier identifier model 810 can include previous supplier email addresses, and the ground-truth data for the email addresses can be the known (or predicted) supplier name associated with each email address. If the modification is a change to a known supplier name, the data processing system can modify the ground-truth data of each item of training data to reflect the modification.

When the user provides modified metadata keywords (e.g., for a particular supplier, or for a default metadata keyword), the data processing system can retrain the keyword extraction model used in the dynamic extraction process 840. The data processing system can retrain the keyword mapping model using processes similar to those described in connection with the other machine learning models described herein. The training data used to train or retrain the keyword extraction model can be previously submitted invoice files, and the ground-truth data can be the known mapping of keywords to metadata extracted from the invoice files. If the user modifies a corresponding metadata keyword, the data processing system can modify the ground-truth data to reflect the modification, and retrain the model accordingly. Examples of metadata keyword pairs extracted from an example invoice file are shown in FIG. 9.

Referring to FIG. 9, depicted is an example user interface showing an example document and extracted key-pair values, in accordance with one or more implementations. As shown in the left-hand portion of the user interface, the document file is rendered with text information encompassed by bounding boxes, which represent text blocks that were extracted from the document. By performing the analysis techniques described herein on the extracted blocks, key-pair values can be determined from the invoice file. The right-hand portion of the user interface shows various keywords, such as “Invoice #,” “Invoice Date”, “Page,” and “Acct #,” among others, which are populated with respective metadata values extracted from the invoice file using the techniques described herein. The keywords may be used in horizontal or vertical extraction techniques to identify corresponding metadata. In addition, mappings between keywords and metadata for different suppliers may be generated using the keyword extraction model described in connection with FIG. 8. As shown, the extracted metadata may be stored in association with its associated keyword in one or more data structures, and may be used in further invoice processing techniques or provided to other computing devices for presentation.

Implementations of the subject matter and the operations described in this specification can be implemented in digital electronic circuitry, or in computer software embodied on a tangible medium, firmware, or hardware, including the structures disclosed in this specification and their structural equivalents, or in combinations of one or more of them. Implementations of the subject matter described in this specification can be implemented as one or more computer programs, e.g., one or more components of computer program instructions, encoded on computer storage medium for execution by, or to control the operation of, data processing apparatus. The program instructions can be encoded on an artificially-generated propagated signal, e.g., a machine-generated electrical, optical, or electromagnetic signal that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can include a source or destination of computer program instructions encoded in an artificially-generated propagated signal. The computer storage medium can also be, or be included in, one or more separate physical components or media (e.g., multiple CDs, disks, or other storage devices).

The operations described in this specification can be implemented as operations performed by a data processing apparatus on data stored on one or more computer-readable storage devices or received from other sources.

The terms “data processing apparatus”, “data processing system”, “client device”, “computing platform”, “computing device”, or “device” encompasses all kinds of apparatus, devices, and machines for processing data, including by way of example a programmable processor, a computer, a system on a chip, or multiple ones, or combinations, of the foregoing. The apparatus can include special purpose logic circuitry, e.g., an FPGA (field programmable gate array) or an ASIC (application-specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform actions by operating on input data and generating output. The processes and logic flows can also be performed by, and apparatuses can also be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. The elements of a computer include a processor for performing actions in accordance with instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive), for example. Devices suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, implementations of the subject matter described in this specification can be implemented on a computer having a display device, e.g., a CRT (cathode ray tube), plasma, or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can include any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Implementations of the subject matter described in this specification can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system such as the data processing system 205 can include clients and servers. For example, the data processing system 205 can include one or more servers in one or more data centers or server farms. A client and server are generally remote from each other and typically interact through a communication network. The relationship of client and server arises by virtue of computer programs running on the respective computers and having a client-server relationship to each other. In some implementations, a server transmits data (e.g., an HTML, page) to a client device (e.g., for purposes of displaying data to and receiving input from a user interacting with the client device). Data generated at the client device (e.g., a result of an interaction, computation, or any other event or computation) can be received from the client device at the server, and vice-versa.

While this specification contains many specific implementation details, these should not be construed as limitations on the scope of any inventions or of what may be claimed, but rather as descriptions of features specific to particular implementations of the systems and methods described herein. Certain features that are described in this specification in the context of separate implementations can also be implemented in combination in a single implementation. Conversely, various features that are described in the context of a single implementation can also be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In some cases, the actions recited in the claims can be performed in a different order and still achieve desirable results. In addition, the processes depicted in the accompanying figures do not necessarily require the particular order shown, or sequential order, to achieve desirable results.

In certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products. For example, the data processing system 205 could be a single module, a logic device having one or more processing modules, one or more servers, or part of a search engine.

Having now described some illustrative implementations, it is apparent that the foregoing is illustrative and not limiting, having been presented by way of example. In particular, although many of the examples presented herein involve specific combinations of method acts or system elements, those acts and those elements may be combined in other ways to accomplish the same objectives. Acts, elements and features discussed only in connection with one implementation are not intended to be excluded from a similar role in other implementations or implementations.

The phraseology and terminology used herein is for the purpose of description and should not be regarded as limiting. The use of “including” “comprising” “having” “containing” “involving” “characterized by” “characterized in that” and variations thereof herein, is meant to encompass the items listed thereafter, equivalents thereof, and additional items, as well as alternate implementations consisting of the items listed thereafter exclusively. In one implementation, the systems and methods described herein consist of one, each combination of more than one, or all of the described elements, acts, or components.

Any references to implementations or elements or acts of the systems and methods herein referred to in the singular may also embrace implementations including a plurality of these elements, and any references in plural to any implementation or element or act herein may also embrace implementations including only a single element. References in the singular or plural form are not intended to limit the presently disclosed systems or methods, their components, acts, or elements to single or plural configurations. References to any act or element being based on any information, act or element may include implementations where the act or element is based at least in part on any information, act, or element.

Any implementation disclosed herein may be combined with any other implementation, and references to “an implementation,” “some implementations,” “an alternate implementation,” “various implementation,” “one implementation” or the like are not necessarily mutually exclusive and are intended to indicate that a particular feature, structure, or characteristic described in connection with the implementation may be included in at least one implementation. Such terms as used herein are not necessarily all referring to the same implementation. Any implementation may be combined with any other implementation, inclusively or exclusively, in any manner consistent with the aspects and implementations disclosed herein.

References to “or” may be construed as inclusive so that any terms described using “or” may indicate any of a single, more than one, and all of the described terms.

Where technical features in the drawings, detailed description or any claim are followed by reference signs, the reference signs have been included for the sole purpose of increasing the intelligibility of the drawings, detailed description, and claims. Accordingly, neither the reference signs nor their absence have any limiting effect on the scope of any claim elements.

The systems and methods described herein may be embodied in other specific forms without departing from the characteristics thereof. Although the examples provided may be useful for extracting parameters from invoices using a cloud computing system, the systems and methods described herein may be applied to other environments. The foregoing implementations are illustrative rather than limiting of the described systems and methods. The scope of the systems and methods described herein may thus be indicated by the appended claims, rather than the foregoing description, and changes that come within the meaning and range of equivalency of the claims are embraced therein.

What is claimed is:

1. A method, comprising:
identifying, by a data processing system having one or more processors coupled to a memory, an invoice file having a file type that was extracted from a message;
determining, by the data processing system, an extraction process for the invoice file based on the file type;
transmitting, by the data processing system, to a cloud computing system, instructions to process the invoice file using the extraction process;
receiving, by the data processing system, from the cloud computing system, a response message including one or more objects extracted from the invoice file;
extracting, by the data processing system, predetermined invoice parameters from the one or more objects using a first analysis process;
determining, by the data processing system, that the first analysis process failed to extract at least one invoice parameter;
responsive to determining that the first analysis process failed to extract the at least one invoice parameter, extracting, by the data processing system, from the one or more objects, using a second analysis process, the at least one invoice parameter; and
transmitting, by the data processing system, to a node server, responsive to extracting the at least one invoice parameter using the second analysis process, a data structure including the predetermined invoice parameters extracted using the first analysis process and the at least one invoice parameter extracted using the second analysis process.

2. The method of claim 1, further comprising:
receiving, by the data processing system, the message from a client device;
identifying, by the data processing system, the invoice file and the file type of the invoice file based on the message; and
extracting, by the data processing system, the invoice file from the message for storage in one or more data structures.

3. The method of claim 2, wherein the message is an email message, and the invoice file is an attachment included in the email message.

4. The method of claim 1, wherein determining the extraction process for the invoice file further comprises:
determining, by the data processing system, that the file type of the invoice file does not match one or more predetermined file types; and
flagging, by the data processing system, the invoice file as unrecognized.

5. The method of claim 1, wherein receiving the response message from the cloud computing system further comprises:
transmitting, by the data processing system, to the cloud computing system, a status request message identifying the extraction process for the invoice file;
receiving, by the data processing system, from the cloud computing system, a status response message indicating that the extraction process for the invoice file is complete;
transmitting, by the data processing system, to the cloud computing system, a results request message identifying the extraction process for the invoice file; and
receiving, by the data processing system, from the cloud computing system, the response message including the one or more objects in response to the results request message.

6. The method of claim 1, further comprising:
determining, by the data processing system, that the file type of the invoice file does not match a predetermined file type; and
converting, by the data processing system, the invoice file to the predetermined file type.

7. The method of claim 1, wherein the first analysis process is a traverse-based rule extraction process, and wherein extracting predetermined invoice parameters from the one or more objects further comprises extracting, by the data processing system, invoice metadata including at least one of an invoice number, a due date, or an amount due.

8. The method of claim 7, wherein the second analysis process is a regular-expression extraction process.

9. The method of claim 7, wherein determining that the first analysis process failed to extract at least one invoice parameter further comprises identifying, by the data processing system, at least one of an invoice number, a due date, or an amount due that was not extracted using the first analysis process.

10. The method of claim 1, further comprising:
determining, by the data processing system, that both the first analysis process and the second analysis process failed to extract the at least one invoice parameter from the one or more objects; and
flagging, by the data processing system, the invoice file as unrecognized responsive to determining that the first analysis process and the second analysis process failed.

11. The method of claim 1, wherein extracting the predetermined invoice parameters from the objects is further based on a supplier of the invoice file.

12. The method of claim 11, further comprising determining, by the data processing system, the supplier of the invoice file by executing a machine learning classifier using the invoice file as input.

13. The method of claim 12, further comprising training, by the data processing system, the machine learning classifier using a set of training data comprising one or more templates and respective ground-truth data.

14. A system, comprising:
a data processing system comprising one or more processors coupled to a memory, the data processing system configured to:
identify an invoice file having a file type that was extracted from a message;
determine an extraction process for the invoice file based on the file type;
transmit, to a cloud computing system, instructions to process the invoice file using the extraction process;
receive, from the cloud computing system, a response message including one or more objects extracted from the invoice file;
extract predetermined invoice parameters from the one or more objects using a first analysis process;
determine that the first analysis process failed to extract at least one invoice parameter;
responsive to determining that the first analysis process failed to extract the at least one invoice parameter, extract, from the one or more objects, using a second analysis process, the at least one invoice parameter; and
transmit, to a node server, responsive to extracting the at least one invoice parameter using the second analysis process, a data structure including the predetermined invoice parameters extracted using the first analysis process and the at least one invoice parameter extracted using the second analysis process.

15. The system of claim 14, wherein the data processing system is further configured to:
receive the message from a client device;
identify the invoice file and the file type of the invoice file based on the message; and
extract the invoice file from the message for storage in one or more data structures.

16. The system of claim 14, wherein the data processing system is further configured to:
determine that the file type of the invoice file does not match a predetermined file type; and
convert the invoice file to the predetermined file type.

17. The system of claim 14, wherein the first analysis process is a traverse-based rule extraction process, and wherein to extract predetermined invoice parameters from the one or more objects, the data processing system is further configured to extract invoice metadata including at least one of an invoice number, a due date, or an amount due.

18. The system of claim 14, wherein the data processing system is further configured to extract the predetermined invoice parameters from the objects further based on a supplier of the invoice file.

19. The system of claim 18, wherein the data processing system is further configured to determine the supplier of the invoice file by executing a machine learning classifier using the invoice file as input.

20. The system of claim 19, wherein the data processing system is further configured to train the machine learning classifier using a set of training data comprising one or more templates and respective ground-truth data.

21. A method, comprising:
determining, by a data processing system having one or more processors coupled to a memory, an extraction process for a document based on a file type of the document;
transmitting, by the data processing system, to a cloud computing system, instructions to process the document using the extraction process;
receiving, by the data processing system, from the cloud computing system, a response message including one or more objects extracted;
extracting, by the data processing system, predetermined parameters from the one or more objects using a first analysis process;
determining, by the data processing system, that the first analysis process failed to extract at least one parameter;
responsive to determining that the first analysis process failed to extract the at least one parameter, extracting, by the data processing system, from the one or more objects, using a second analysis process, the at least one parameter; and
transmitting, by the data processing system, to a node server, responsive to extracting the at least one parameter using the second analysis process, a data structure including the predetermined parameters extracted using the first analysis process and the at least one parameter extracted using the second analysis process.

22. A method, comprising:
identifying, by a data processing system having one or more processors coupled to a memory, an invoice file having a file type, the invoice file associated with a supplier identifier;
transmitting, by the data processing system, to a cloud computing system, instructions to process the invoice file using an extraction process;
receiving, by the data processing system, from the cloud computing system, a response message including one or more objects extracted from the invoice file; and
extracting, by the data processing system, predetermined invoice parameters from the one or more objects based on one or more predetermined keywords associated with the supplier identifier and one or more coordinates identified for the one or more objects.

23. The method of claim 22, further comprising determining, by the data processing system, using an invoice supplier identifier model, the supplier identifier associated with the invoice file.
